(19) United States
(12) Patent Application Publication
(10) Pub. No.: US 2021/0036864 A1
(43) Pub. Date: Feb. 4, 2021

(54) METHOD AND SYSTEM FOR GENERATING A KECCAK MESSAGE AUTHENTICATION CODE (KMAC) BASED ON WHITE-BOX IMPLEMENTATION

(71) Applicant: Agency for Science, Technology and Research, Singapore (SG)

(72) Inventors: Jiqiang Lu, Singapore (SG); Huaqun Guo, Singapore (SG)

(21) Appl. No.: 17/042,548

(22) PCT Filed: Mar. 29, 2019
(86) PCT No.: PCT/SG2019/050187

§ 371 Date: Sep. 28, 2020

(30) Foreign Application Priority Data
Mar. 29, 2018 (SG) 10201802659S

(51) Int. Cl. H04L 9/32; H04L 9/06; H04L 9/00

(52) U.S. Cl. CPC H04L 9/3242; H04L 9/002; H04L 9/0643; H04L 9/3226

(57) ABSTRACT

There is provided a method of generating a Keccak message authentication code (KMAC) based on white-box implementation, using at least one processor. The method includes: obtaining a white-box implementation of a round function of a KMAC algorithm; receiving an input message; obtaining a plurality of message blocks based on the input message; and for each of the plurality of message blocks at a plurality of iterations, respectively: modifying a current state of the KMAC algorithm based on the message block to produce a modified current state of the KMAC algorithm; inputting the modified current state to a state transformation function including the white-box implementation of the round function; and executing the white-box implementation of the round function based on the modified current state to obtain an updated state of the KMAC algorithm as an output of the state transformation function. In particular, the modified current state inputted to the state transformation function and the updated state outputted from the state transformation function are each white-box protected based on a same set of white-box operations. There is also provided a corresponding system for generating a KMAC based on white-box implementation.

### CROSS-REFERENCE TO RELATED APPLICATION

This application claims the benefit of priority of Singapore Patent Application No. 10201802659S, filed 29 Mar. 2018, the content of which being hereby incorporated by reference in its entirety for all purposes.

### TECHNICAL FIELD

The present invention generally relates to a method of generating a Keccak message authentication code (KMAC) based on white-box implementation, and a system thereof.

### BACKGROUND

In the Internet of Things (IoT), a digital service such as online games, songs, TV and video programs is distributed by the service provider from a server to a client app running in a physical device (e.g., game console, mobile phone, set-top box). The client's device needs to authenticate some attributes associated with the digital contents, e.g., the contents originate from the right server and have not been tampered by a third party to include malware.

A common authentication method is to use a message authentication code (MAC) where the client's device will compute the digest of digital content and compare with that received together from the server. However, IoT devices (e.g. mobile phone, game console and TV box) usually operates on a platform which is under partial or full control of the device owner. The device owner has control of the service device and can access the source code and intermediate results of a cryptographic implementation. Under a plain message authentication code, KMAC implementation, device owners can extract the secret key, and generate the digest of a message of his own choice. This security compromise may allow device owner to carry out malicious and unauthorized activities, e.g. accessing paid TV programs without paying.

There is a need to prevent the device owners from extracting the secret key (known as key extraction attacks), and preventing the device owners from generating the digest of an unauthorized message (known as code lifting attacks), while performing KMAC computations efficiently on clients' devices.

A need therefore exists to provide a method of generating a KMAC based on white-box implementation, and a system thereof, such as but not limited to, improving or enhancing security in message authentication code (e.g., addressing or mitigating key extraction and code lifting attacks). It is against this background that the present invention has been developed.

### SUMMARY

According to a first aspect of the present invention, there is provided a method of generating a Keccak message authentication code (KMAC) based on white-box implementation, using at least one processor, the method comprising:
obtaining a white-box implementation of a round function of a KMAC algorithm;
receiving an input message;
obtaining a plurality of message blocks based on the input message; and
for each of the plurality of message blocks at a plurality of iterations, respectively:
   modifying a current state of the KMAC algorithm based on the message block to produce a modified current state of the KMAC algorithm;
   inputting the modified current state to a state transformation function comprising the white-box implementation of the round function; and
   executing the white-box implementation of the round function based on the modified current state to obtain an updated state of the KMAC algorithm as an output of the state transformation function,
whereby the modified current state inputted to the state transformation function and the updated state outputted from the state transformation function are each white-box protected based on a same set of white-box operations.

According to a second aspect of the present invention, there is provided a system for generating a KMAC based on white-box implementation, the system comprising:
a memory; and
at least one processor communicatively coupled to the memory and configured to:
   obtain a white-box implementation of a round function of a KMAC algorithm;
   receive an input message;
   obtain a plurality of message blocks based on the input message; and
   for each of the plurality of message blocks at a plurality of iterations, respectively:
      modify a current state of the KMAC algorithm based on the message block to produce a modified current state of the KMAC algorithm;
      input the modified current state to a state transformation function comprising the white-box implementation of the round function; and
      execute the white-box implementation of the round function based on the modified current state to obtain an updated state of the KMAC algorithm as an output of the state transformation function,
whereby the modified current state inputted to the state transformation function and the updated state outputted from the state transformation function are each white-box protected based on a same set of white-box operations.

According to a third aspect of the present invention, there is provided a computer program product, embodied in one or more non-transitory computer-readable storage mediums, comprising instructions executable by at least one processor to perform a method of generating a KMAC based on white-box implementation, the method comprising:
obtaining a white-box implementation of a round function of a KMAC algorithm;
receiving an input message;
obtaining a plurality of message blocks based on the input message; and
for each of the plurality of message blocks at a plurality of iterations, respectively:
   modifying a current state of the KMAC algorithm based on the message block to produce a modified current state of the KMAC algorithm;
   inputting the modified current state to a state transformation function comprising the white-box implementation of the round function; and
   executing the white-box implementation of the round function based on the modified current state to obtain an updated state of the KMAC algorithm as an output of the state transformation function,
whereby the modified current state inputted to the state transformation function and the updated state outputted from the state transformation function are each white-box protected based on a same set of white-box operations.

### BRIEF DESCRIPTION OF THE DRAWINGS

Embodiments of the present invention will be better understood and readily apparent to one of ordinary skill in the art from the following written description, by way of example only, and in conjunction with the drawings, in which:

FIG. 1 depicts a flow diagram illustrating a method of generating a KMAC based on white-box implementation according to various embodiments of the present invention;

FIG. 2 depicts a schematic block diagram of a system for generating a KMAC based on white-box implementation, according to various embodiments of the present invention;

FIG. 3 depicts a schematic block diagram of an exemplary computer system which may be used to realize or implement the system as depicted in FIG. 3;

FIG. 4 depicts a schematic drawing illustrating a conventional sponge construction;

FIGS. 5A and 5B depict schematic drawings illustrating conventional general structures of HMAC and KMAC, respectively;

FIG. 6A illustrates a white-box implementations of a round function of a KMAC algorithm according to various example embodiments of the present invention;

FIGS. 6B to 6F are enlarged versions of various portions of FIG. 6A for better clarity;

FIG. 7A illustrate a white-box implementation of the X⊕Y operation according to various example embodiments of the present invention;

FIGS. 7B to 7D illustrate enlarged versions of various portions of FIG. 7A for better clarity;

FIG. 8A illustrate a white-box implementation of the (¬X) & Y operation according to various example embodiments of the present invention;

FIGS. 8B to 8D illustrate enlarged versions of various portions of FIG. 8A for better clarity;

FIG. 9A illustrate a white-box implementation of the X<<<α operation according to various example embodiments of the present invention;

FIGS. 9B to 9D illustrate enlarged versions of various portions of FIG. 9A for better clarity;

FIG. 10A illustrate a white-box implementation of the X⊕RCᵢ operation according to various example embodiments of the present invention; and

FIGS. 10B and 10C illustrate enlarged versions of various portions of FIG. 10A for better clarity.

### DETAILED DESCRIPTION

Various embodiments of the present invention provide a method of generating a Keccak message authentication code (KMAC) based on white-box implementation, and a system thereof.

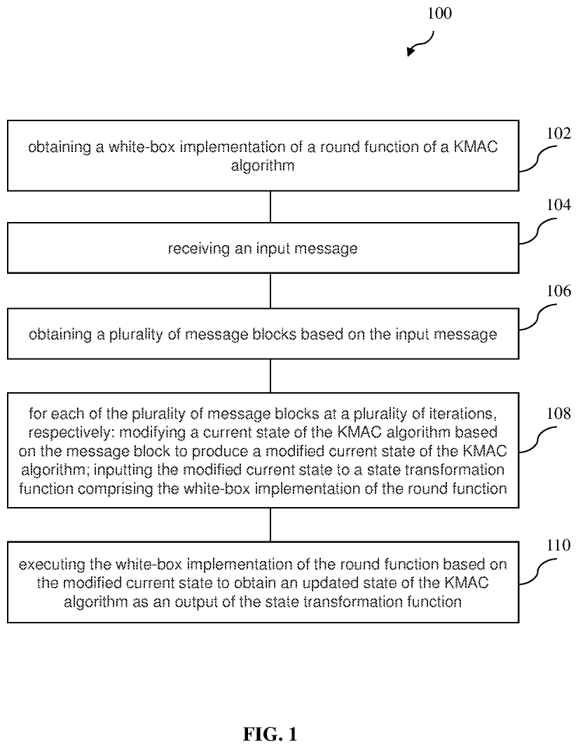

FIG. 1 depicts a flow diagram illustrating a method 100 of generating a KMAC based on white-box implementation, using at least one processor, the method 100 comprising: obtaining (at 102) a white-box implementation of a round function of a KMAC algorithm; receiving (at 104) an input message; obtaining (at 106) a plurality of message blocks based on the input message; and (at 108) for each of the plurality of message blocks at a plurality of iterations, respectively: modifying a current state (e.g., current internal state) of the KMAC algorithm based on the message block to produce a modified current state (e.g., modified current internal state) of the KMAC algorithm; inputting the modified current state to a state transformation function comprising the white-box implementation of the round function; and executing (at 110) the white-box implementation of the round function based on the modified current state to obtain an updated state of the KMAC algorithm as an output of the state transformation function. In particular, the modified current state inputted to the state transformation function and the updated state outputted from the state transformation function are each white-box protected based on a same set of white-box operations.

As a result, for example, the white-box implementation output of the state transformation function of a message block has the same format as the white-box implementation output of the state transformation function of the previous message block (if any), so the white-box implementation of the round function of the KMAC algorithm according to various embodiments can be advantageously iterated (reused) for the plurality of message blocks. For example, most of the five operations of the round function can be iteratively reused in different rounds, except that the operations dealing with the round constants are dedicated to the respective rounds.

In various embodiments, the above-mentioned modifying (at 108) the current state comprises performing an exclusive OR (XOR) operation between the current state and the message block, the current state and the message block are each white-box protected, and the current state is white-box protected based on said same set of white-box operations.

In various embodiments, the above-mentioned executing (at 110) the white-box implementation of the round function based on the modified current state comprises executing the white-box implementation of the round function iteratively in a plurality of rounds, and at each round of the plurality of rounds, a state of the KMAC algorithm input to the white-box implementation of the round function and a state of the KMAC algorithm output from the white-box implementation of the round function are each white-box protected based on said same set of white-box operations.

In various embodiments, the white-box implementation of the round function comprises a plurality of component white-box implementations for a plurality of elementary operations of the round function, and at least one of the plurality of component white-box implementations are used in the white-box implementation of the round function at each of the plurality of rounds.

In various embodiments, at least one of the plurality of component white-box implementations are used in the white-box implementation of the round function at each of the plurality of iterations with respect to the plurality of message blocks.

In various embodiments, the plurality of elementary operations of the round function comprises a theta operation, a rho operation, a pi operation, a chi operation and an iota operation, and the plurality of component white-box implementations comprises a first component white-box implementation for the theta operation, a second component white-box implementation for the rho and pi operations, a third component white-box implementation for the chi operation and a fourth white-box implementation for the iota operation.

In various embodiments, the first component white-box implementation, the second component white-box implementation and the third component white-box implementation are used at the white-box implementation of the round function at each of the plurality of rounds.

In various embodiments, the first and second component white-box implementations each comprises a first basic white-box implementation of a rotation operation, the first basic white-box implementation comprising a plurality of white-box implementations for a plurality of parallel XOR operations, wherein each white-box implementation for each of the plurality of parallel XOR operations: inputs two adjacent fractions of an input to the first basic white-box implementation as two input operands; applies left shift and right shift operations (e.g., of certain numbers) to the two adjacent fractions, respectively, to obtain a first fraction output and a second fraction output; and performs an XOR operation between the first fraction output and the second fraction output (e.g., with white-box protection).

In various embodiments, the fourth component white-box implementation comprises a second basic white-box implementation of a round constant related XOR operation for each of the plurality of rounds, whereby the second basic white-box implementation for each round after a first round of the plurality of rounds only updates white-box operations related to output bytes of an XOR operation affected by a round constant for the round, and for remaining output bytes of the XOR operation unaffected by the round constant, reuse white-box operations related to corresponding output bytes of the second basic white-box implementation at the first round. For example, this may also save memory and reduce storage complexity.

In various embodiments, the second basic white-box implementation incorporates the XOR operation with a round constant into the internal computation of generating the white-box implementation, without treating the round constant as an explicit input to the white-box implementation. For example, this may also save memory and reduce storage complexity.

In various embodiments, the above-mentioned same set of white-box operations is a global set of white-box operations with respect to the KMAC algorithm, and the above-mentioned same set of white-box operations comprises an array of mixing bijection operations and an array of external encoding operations.

In various embodiments, the KMAC algorithm comprises an absorbing phase (or message phase) and a squeezing phase (or digest phase). In this regard, 104, 106, 108 and 110 correspond to the absorbing phase. In various embodiments, the white-box implementation of the round function described hereinbefore according to various embodiments is also advantageously applied or employed in the squeezing phase to produce the KMAC (i.e., digest). In other words, the white-box implementation of the round function described hereinbefore according to various embodiments is advantageously configured or formed so as to be able to be used in the absorbing phase and reused in the squeezing phase. Accordingly, the white-box implementation of the round function of the KMAC algorithm according to various embodiments can be advantageously iterated (used and/or reused) throughout the entire phase (i.e., absorbing and squeezing phase) of the KMAC algorithm to generate the KMAC (i.e., digest).

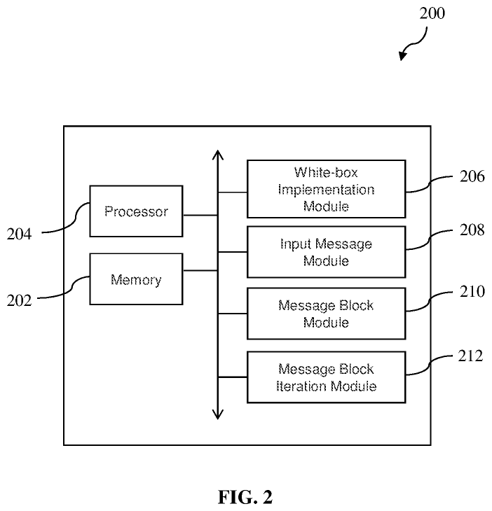

FIG. 2 depicts a schematic block diagram of a system 200 for generating a KMAC based on white-box implementation, according to various embodiments of the present invention, such as corresponding to the method 100 of generating a KMAC based on white-box implementation as described hereinbefore according to various embodiments of the present invention. The system 200 comprises a memory 202, and at least one processor 204 communicatively coupled to the memory 202 and configured to: obtain a white-box implementation of a round function of a KMAC algorithm; receive an input message; obtain a plurality of message blocks based on the input message; and for each of the plurality of message blocks at a plurality of iterations, respectively: modify a current state of the KMAC algorithm based on the message block to produce a modified current state of the KMAC algorithm; input the modified current state to a state transformation function comprising the white-box implementation of the round function; and execute the white-box implementation of the round function based on the modified current state to obtain an updated state of the KMAC algorithm as an output of the state transformation function. In particular, the modified current state inputted to the state transformation function and the updated state outputted from the state transformation function are each white-box protected based on a same set of white-box operations. It will be appreciated to a person skilled in the art that the system 200 may also be embodied as a device or an apparatus.

It will be appreciated by a person skilled in the art that the at least one processor 204 may be configured to perform the required functions or operations through set(s) of instructions (e.g., software modules) executable by the at least one processor 204 to perform the required functions or operations. Accordingly, as shown in FIG. 2, the system 200 may further comprise a white-box implementation module (or a white-box implementation circuit) 206 configured to perform the above-mentioned obtaining (at 102) a white-box implementation of a round function of a KMAC algorithm; an input message module (or input message circuit) 208 configured to receive an input message; a message block module (or message block circuit) 210 configured to obtain a plurality of message blocks based on the input message; a message block iteration module (or message block iteration circuit) 212 configured to, for each of the plurality of message blocks at a plurality of iterations, respectively: modify a current state of the KMAC algorithm based on the message block to produce a modified current state of the KMAC algorithm; input the modified current state to a state transformation function comprising the white-box implementation of the round function; and execute the white-box implementation of the round function based on the modified current state to obtain an updated state of the KMAC algorithm as an output of the state transformation function.

It will be appreciated by a person skilled in the art that the above-mentioned modules are not necessarily separate modules, and two or more modules may be realized by or implemented as one functional module (e.g., a circuit or a software program) as desired or as appropriate without deviating from the scope of the present invention. For example, the white-box implementation module 206, the input message module 208, the message block module 210 and the message block iteration module 212 may be realized (e.g., compiled together) as one executable software program (e.g., software application or simply referred to as an “app”), which for example may be stored in the memory 202 and executable by the at least one processor 204 to perform the functions/operations as described herein according to various embodiments.

In various embodiments, the system 200 corresponds to the method 100 as described hereinbefore with reference to FIG. 1, therefore, various functions or operations configured to be performed by the least one processor 204 may correspond to various steps of the method 100 described hereinbefore according to various embodiments, and thus need not be repeated with respect to the system 200 for clarity and conciseness. In other words, various embodiments described herein in context of the methods are analogously valid for the respective systems (e.g., which may also be embodied as devices), and vice versa.

For example, in various embodiments, the memory 202 may have stored therein the white-box implementation module 206, the input message module 208, the message block module 210 and/or the message block iteration module 212, which respectively correspond to various steps of the method 100 as described hereinbefore according to various embodiments, which are executable by the at least one processor 204 to perform the corresponding functions/operations as described herein.

A computing system, a controller, a microcontroller or any other system providing a processing capability may be provided according to various embodiments in the present disclosure. Such a system may be taken to include one or more processors and one or more computer-readable storage mediums. For example, the system 200 described hereinbefore may include a processor (or controller) 204 and a computer-readable storage medium (or memory) 202 which are for example used in various processing carried out therein as described herein. A memory or computer-readable storage medium used in various embodiments may be a volatile memory, for example a DRAM (Dynamic Random Access Memory) or a non-volatile memory, for example a PROM (Programmable Read Only Memory), an EPROM (Erasable PROM), EEPROM (Electrically Erasable PROM), or a flash memory, e.g., a floating gate memory, a charge trapping memory, an MRAM (Magnetoresistive Random Access Memory) or a PCRAM (Phase Change Random Access Memory).

In various embodiments, a “circuit” may be understood as any kind of a logic implementing entity, which may be special purpose circuitry or a processor executing software stored in a memory, firmware, or any combination thereof. Thus, in an embodiment, a “circuit” may be a hard-wired logic circuit or a programmable logic circuit such as a programmable processor, e.g., a microprocessor (e.g., a Complex Instruction Set Computer (CISC) processor or a Reduced Instruction Set Computer (RISC) processor). A “circuit” may also be a processor executing software, e.g., any kind of computer program, e.g., a computer program using a virtual machine code, e.g., Java. Any other kind of implementation of the respective functions which will be described in more detail below may also be understood as a “circuit” in accordance with various alternative embodiments. Similarly, a “module” may be a portion of a system according to various embodiments in the present invention and may encompass a “circuit” as above, or may be understood to be any kind of a logic-implementing entity therefrom.

Some portions of the present disclosure are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “obtaining”, “receiving”, “obtaining”, “modifying”, “inputting”, “executing” or the like, refer to the actions and processes of a computer system, or similar electronic device, that manipulates and transforms data represented as physical quantities within the computer system into other data similarly represented as physical quantities within the computer system or other information storage, transmission or display devices.

The present specification also discloses a system (e.g., which may also be embodied as a device or an apparatus) for performing the operations/functions of the methods described herein. Such a system may be specially constructed for the required purposes, or may comprise a general purpose computer or other device selectively activated or reconfigured by a computer program stored in the computer. The algorithms presented herein are not inherently related to any particular computer or other apparatus. Various general-purpose machines may be used with computer programs in accordance with the teachings herein. Alternatively, the construction of more specialized apparatus to perform the required method steps may be appropriate.

In addition, the present specification also at least implicitly discloses a computer program or software/functional module, in that it would be apparent to the person skilled in the art that the individual steps of the methods described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention. It will be appreciated by a person skilled in the art that various modules described herein (e.g., the white-box implementation module 206, the input message module 208, the message block module 210 and/or the message block iteration module 212) may be software module(s) realized by computer program(s) or set(s) of instructions executable by a computer processor to perform the required functions, or may be hardware module(s) being functional hardware unit(s) designed to perform the required functions. It will also be appreciated that a combination of hardware and software modules may be implemented.

Furthermore, one or more of the steps of a computer program/module or method described herein may be performed in parallel rather than sequentially. Such a computer program may be stored on any computer readable medium. The computer readable medium may include storage devices such as magnetic or optical disks, memory chips, or other storage devices suitable for interfacing with a general purpose computer. The computer program when loaded and executed on such a general-purpose computer effectively results in an apparatus that implements the steps of the methods described herein.

In various embodiments, there is provided a computer program product, embodied in one or more computer-readable storage mediums (non-transitory computer-readable storage medium), comprising instructions (e.g., the white-box implementation module 206, the input message module 208, the message block module 210 and the message block iteration module 212) executable by one or more computer processors to perform a method 100 of generating a KMAC based on white-box implementation as described hereinbefore with reference to FIG. 1. Accordingly, various computer programs or modules described herein may be stored in a computer program product receivable by a system therein, such as the system 200 as shown in FIG. 2, for execution by at least one processor 204 of the system 200 to perform the required or desired functions.

The software or functional modules described herein may also be implemented as hardware modules. More particularly, in the hardware sense, a module is a functional hardware unit designed for use with other components or modules. For example, a module may be implemented using discrete electronic components, or it can form a portion of an entire electronic circuit such as an Application Specific Integrated Circuit (ASIC). Numerous other possibilities exist. Those skilled in the art will appreciate that the software or functional module(s) described herein can also be implemented as a combination of hardware and software modules.

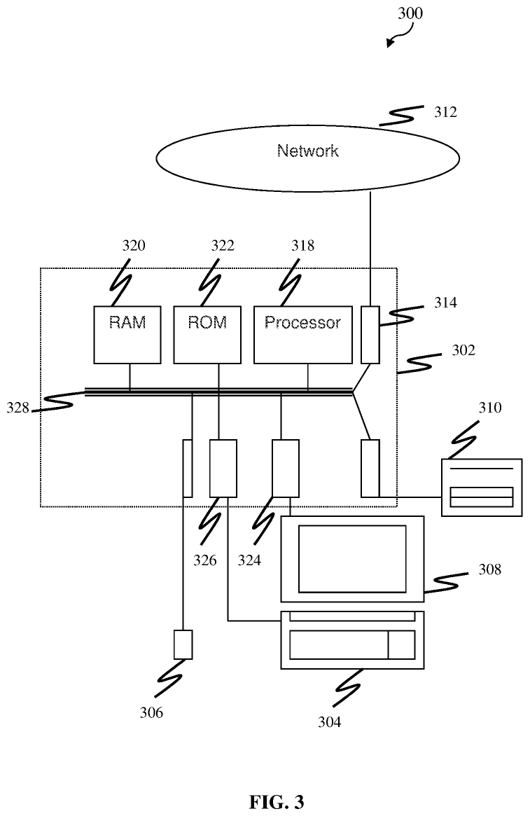

In various embodiments, the system 200 may be realized by any computer system (e.g., portable or desktop computer system, such as tablet computers, laptop computers, mobile communications devices (e.g., smart phones), and so on) including at least one processor and a memory, such as a computer system 300 as schematically shown in FIG. 3 as an example only and without limitation. Various methods/steps or functional modules (e.g., the component extractor 206 and/or the data graph generator 208) may be implemented as software, such as a computer program being executed within the computer system 300, and instructing the computer system 300 (in particular, one or more processors therein) to conduct the methods/functions of various embodiments described herein. The computer system 300 may comprise a computer module 302, input modules, such as a keyboard 304 and a mouse 306, and a plurality of output devices such as a display 308, and a printer 310. The computer module 302 may be connected to a computer network 312 via a suitable transceiver device 314, to enable access to e.g., the Internet or other network systems such as Local Area Network (LAN) or Wide Area Network (WAN). The computer module 302 in the example may include a processor 318 for executing various instructions, a Random Access Memory (RAM) 320 and a Read Only Memory (ROM) 322. The computer module 302 may also include a number of Input/Output (I/O) interfaces, for example I/O interface 324 to the display 308, and I/O interface 326 to the keyboard 304. The components of the computer module 302 typically communicate via an interconnected bus 328 and in a manner known to the person skilled in the relevant art.

It will be appreciated by a person skilled in the art that the terminology used herein is for the purpose of describing various embodiments only and is not intended to be limiting of the present invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

In order that the present invention may be readily understood and put into practical effect, various example embodiments of the present invention will be described hereinafter by way of examples only and not limitations. It will be appreciated by a person skilled in the art that the present invention may, however, be embodied in various different forms or configurations and should not be construed as limited to the example embodiments set forth hereinafter. Rather, these example embodiments are provided so that this disclosure will be thorough and complete, and will fully convey the scope of the present invention to those skilled in the art.

Various example embodiments relate to securing a message authentication code, and more specifically, a white-box implementation of a message authentication code.

### 1—Introduction

In 2005, serious collision attacks were published on then hash function standards MD5 and SHA-1. As a consequence, U.S. National Institute of Standards and Technology (NIST) announced the public SHA-3 competition to develop an alternative but dissimilar cryptographic hash standard in 2007, selected the candidate Keccak through the SHA-3 competition in 2012, and finally approved it as the new-generation SHA-3 hash standard in 2015. SHA-3 is based on the sponge construction method (such as disclosed in Bertoni G. et al., “Sponge functions. In: ENCRYPT Hash Workshop 2007 (2007)”, the content of which being hereby incorporated by reference in its entirety for all purposes), which is quite different from the Merkle-Damgård construction method that earlier hash functions like MD5 and SHA-1/2 are based on. SHA-3 has been adopted by real-life applications like Ethereum.

The HMAC message authentication code (MAC) was proposed in 1996 mainly for use with a Merkle-Damgård hash function like SHA-1/2, since a Merkle-Damgård hash function cannot be readily transformed into a secure MAC for authenticity by prepending a key to message, that is, an attacker can append one or more message blocks and is able to compute the resulting MAC, which is known as length extension attack. HMAC uses a nested structure to prevent length extension attacks, however, a sponge hash function can prevent length extension attacks itself, mainly because the internal states are not fully released as output. Thus, HMAC would be not efficient with a sponge hash function. In 2016, NIST released the KMAC algorithm for use with SHA-3 to provide authenticity, which is actually a keyed variant of SHA-3, simply by prepending a padded key to message.

White-box cryptography was introduced in 2002, together with its applications to the AES and DES block ciphers. It works under the so-called white-box model, which gives an attacker much more power than the so-called blackbox and grey-box models, and assumes an attacker to have access to every execution instruction of a software implementation, besides the power from the black-box and grey-box models. White-box cryptography has a great demand in reality, particularly in the current IoT (Internet of Things) era, and many IT companies like APPLE and MIRCROSOFT already use or plan to use white-box cryptography solutions, since nowadays there are many real-life scenarios such as TV boxes, mobile phones and game consoles, where the owner/user of a client service device may compromise the underlying security mechanism for unauthorised or malicious use of the service. Key extraction attack is the basic security threat for a white-box cryptographic implementation, whose target is to extract the key used in the implementation. Another serious attack in white-box cryptography is what we call code lifting attack, whose target is to use white-box implementation to generate the correct output for an input of his choice, instead of extracting the key. At present, there are mainly two research directions on white-box cryptography: one is the design and analysis of white-box implementations of existing cryptographic algorithms and standards, and it has been well understood that this line of designs is nearly impossible to achieve a full security but can still provide a practical significance more or less; and the other research direction is the design and analysis of completely new white-box primitives that primarily aim to achieve a full security. Both the directions have their respective applications in reality.

Various example embodiments fall in the first direction of white-box cryptography, and two main technical contributions according to various example embodiments are as follows:
KMAC can be decomposed into four basic operations, namely (bitwise) XOR, AND, NOT and rotation (on 64-bit words). Previous work has elaborated white-box implementations of XOR, AND and NOT operations. Various example embodiments describe a white-box implementation of rotation operation.
Various example embodiments observe that the following two particular distinctions between the two types of hash functions make a huge difference to white-box implementations of their corresponding MACs: 1) The compression function of a Merkle-Damgård hash function like SHA-1/2 is one-way (i.e. irreversible), while the state transformation function of a sponge hash function like SHA-3 is usually a permutation, which is bijective and reversible; and 2) A Merkle-Damgård hash function like SHA-1/2 usually involves a message expansion function, while a sponge hash function does not involve a message expansion function. The first distinction makes it complex to design an efficient white-box implementation against key extraction attacks for KMAC, while it is rather simple for HMAC-SHA-1/2; and the second distinction makes it relatively easier to design an efficient white-box implementation against both key extraction and code lifting attacks for KMAC than for HMAC-SHA-1/2, with only slight additional cost compared with the case of only key extraction attacks. Finally, various example embodiments present an efficient white-box implementation of KMAC by taking advantage of its features for an iterative process at different phases, which can practically resist both key extraction and code lifting attacks (e.g., to some extent), can produce a variable-length digest for an arbitrary length message and can still work when the key is updated to a different one.

In particular, the round function of KMAC takes only an earlier internal state and some fixed constants as input (without key or message input), and thus in the general sense, various example embodiments can iteratively reuse most of the white-box implementation of the round function in different rounds, which is different from the white-box implementations of DES, AES and HMAC. Various example embodiments note that various trade-offs between security and performance can be made from the white-box KMAC implementation by using different dimension sizes to mixing bijections, external encodings and white-box tables, and the white-box KMAC implementation can be readily applied to variants and extensions of the sponge construction, e.g., the duplex construction.

The following description according to various example embodiments are organised as follows. In the next section, the notation, the sponge construction method, SHA-3 and KMAC are described. In Section 3, main distinctions between white-box implementations of KMAC and HMAC are described. A white-box implementation schema of KMAC according to various example embodiments is described in Section 4, white-box implementations of basic operations according to various example embodiments are presented in Section 5, and an example white-box KMAC implementation according to various example embodiments is presented in Section 6.

### 2—Preliminaries

In this section, various notations used herein are provided, and the sponge construction method, SHA-3 and KMAC are briefly described.

### 2.1—Notation

In all descriptions we assume that the bits of a value are numbered from left to right, starting with 0; a number without a prefix expresses a decimal number unless stated otherwise, and a number with prefix Ox expresses a hexadecimal number. The following notations are used herein.
⊕ bitwise logical exclusive OR (XOR)
& bitwise logical AND
¬ the complement (NOT)
<<(>>) left (right) shift of a bit string
<<< left rotation of a bit string
∥ bit string concatenation
° functional composition. When composing functions X and Y, X ° Y denotes the function obtained by first applying X and then applying Y
└X┘ the largest integer that is less than or equal to X

### 2.2—The Sponge Hash Function Construction Method

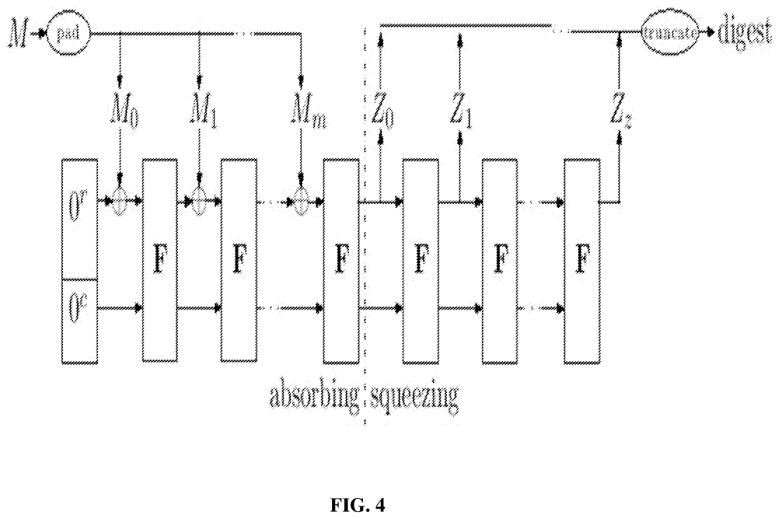

The sponge construction was first proposed by Bertoni et al. As illustrated in FIG. 4, for some positive integers r and c, a sponge construction maps binary strings with bit length of a multiple of r into binary strings of any requested length (i.e. [symbol] ₂^{r,*} to [symbol] ₂^{∞}, by calling a transformation F: [symbol] ₂^{r+c}→ [symbol] ^{r+c} where r is called the bitrate (of the sponge construction), c is called the capacity (of the sponge construction) which should be twice the length of the requested digest, and F is often referred to as the state transformation function (of the sponge construction). Note that a message M should be padded first to reach a bit length of a minimum multiple of r, and then divided into a number of r-bit blocks M₀, M₁, . . . , Mₘ; and the digest Z is made up of r-bit blocks Z₀, Z₁, . . . , Z_{z} with the last block being truncated to meet the requested digest length if necessary.

A sponge construction consists of two phases at a high level: absorbing phase and squeezing phase. The absorbing phase processes a message, and the squeezing phase outputs a (message) digest (or hash value).

### 2.3—The SHA-3 Hash Function Family

SHA-3 is a family of four cryptographic hash functions and two extendable-output functions. Various example embodiments focus on the SHA-3 hash function member with a 256-bit digest, that is SHA3-256, the detailed specification can be found in NIST: SHA-3 Standard: Permutation-Based Hash and Extendable-Output Functions, FIPS-202 (2015), the content of which being hereby incorporated by reference in its entirety for all purposes.

For SHA3-256, the capacity c=512, the bitrate r=1088, the digest length is 256, and a message is padded by appending first three bits ‘011’, then as many zeros as minimally required and finally one-bit ‘1’ to reach a bit length of a multiple of r, where the first two bits of ‘011’ are used as a suffix to the message to distinguish the SHA-3 hash functions from the SHA-3 extendable-output functions.

For all SHA3 members, the state transformation function F is a permutation operating on binary strings of 1600 bits (that is r+c) long. A 1600-bit state is represented as a 5×5×64 bit array of three dimensions, denoted by A={A[x, y, z]|0≤x≤4, 0≤y≤4, 0≤z≤63}. The state transformation function F includes the following five elementary operations, where Â={Â[x, y, z]|0≤x≤4, 0≤y≤4, 0≤z≤63} is a 5×5×64 bit array variable:

```
  θ: θ(A) = Â is defined as the following three steps:
  1. For 0 ≤ x ≤ 4 and 0 ≤ z ≤ 63:
```

| | |
|---|---|
| C[x, z] = ⊕_{y=0}⁴ A[x, y, z] | (1) |
| 2. For 0 ≤ x ≤ 4 and 0 ≤ z ≤ 63: | |
| D[x, z]= C[(x − 1) mod 5, z] ⊕ C[(x + 1) mod 5, (z − 1) mod 64] | (2) |
| 3. For 0 ≤ x ≤ 4, 0 ≤ y ≤ 4, 0 ≤ z ≤ 63: | |
| Â[x, y, z] = A[x, y, z] ⊕ D[x, z]. | |
| ρ: ρ(A) = Â is defined as the following three steps: | |
| 1. For 0 ≤ z ≤ 63: | |
| Â[0, 0, z] = A[0, 0, z]. | |
| 2. (x, y) = (1, 0). | |
| 3. For t = 0 to 23: | |
| a) For 0 ≤ z ≤ 63: | |
| $\hat{A} [ x , y , z ] = A [ x , y , ( z - \frac{( t + 1 ) \times ( t + 2 )}{2} ) mod 64 ]$ | (3) |
| b) (x, y) = (y, (2x + 3y) mod 5). | |
| π: π(A) = Â is defined as follows: | |
| For 0 ≤ x ≤ 4, 0 ≤ y ≤ 4, 0 ≤ z ≤ 63: | |
| Â[x, y, z] = A[(x + 3y) mod 5, x, z]. | (4) |
| χ: χ(A) = Â is defined as the following three steps: | |
| For 0 ≤ x ≤ 4, 0 ≤ y ≤ 4, 0 ≤ z ≤ 63: | |
| Â[x, y, z] = A[x, y, z] ⊕ ((A[(x + 1) mod 5, y, z] ⊕ 1) × A[(x + 2) mod 5, y, z]) | (5) |
| ι: ι(A, i) = Â is defined as the following four steps, where i is the round index | |
| (0 ≤ i ≤ 23), and RCᵢ = RCᵢ[0]\|\|RCᵢ[1]\|\| . . . \|\|RCᵢ[63] are 64-bit round constants | |
| generated by a function rc(·): | |
| 1. For 0 ≤ x ≤ 4, 0 ≤ y ≤ 4, 0 ≤ z ≤ 63: | |
| Â[x, y, z] = A[x, y, z]. | |
| 2. RC = 0⁶⁴. | |
| 3. For j = 0 to 6: | |
| RCᵢ[2^{j} − 1] = rc(j + 7i). | |
| 4. For 0 ≤ z ≤ 63: | |
| Â[0, 0, z] = A[0, 0, z] ⊕ RCᵢ[z] | (6) |

The round function of SHA-3 is defined to be ι(χ(π(ρ(θ(A)))), i), where i is the round index (0≤i≤23). The state transformation function F of SHA-3 is an iteration of the round function 24 times with the round index i from 0 to 23 sequentially, defined as follows: A=ι(χ(π(ρ(θ(A)))), i) for i=0 to 23.

### 2.4—the KMAC Message Authentication Code

The KMAC message authentication code was released in 2016 (NIST: Derived Functions: cSHAKE, KMAC, TupleHash and ParallelHash, NIST Special Publication 800-185 (2016), the content of which being hereby incorporated by reference in its entirety for all purposes), which is actually a keyed SHA-3. KMAC is defined as KMAC(K,M)=H(pad(K)∥M), where H is a member of the Keccak hash family, and K is a 128-bit or 256-bit user key. That is, the padded key together with the original message is treated as the input message in Keccak, with the first r-bit message block being the padded key.

### 3—Various Distinctions Between White-Box Implementations of KMAC and HMAC

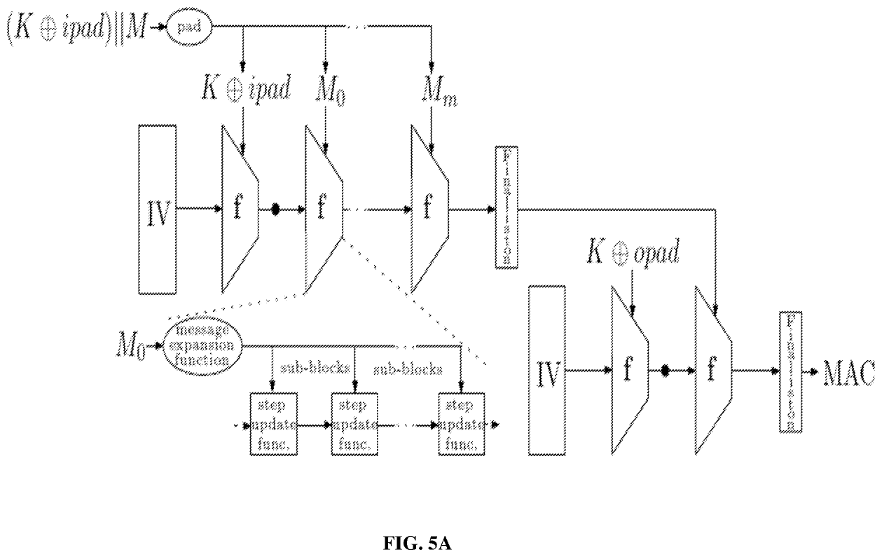

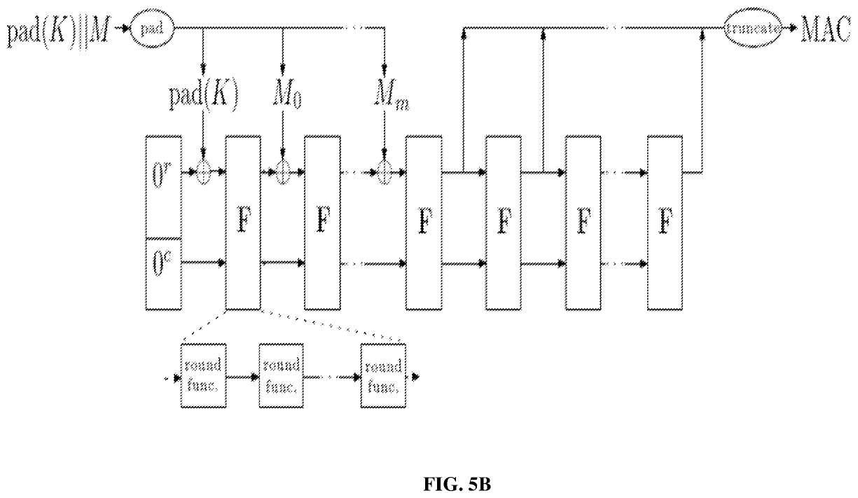

In this section, two main distinctions between white-box implementations of KMAC and HMAC are discussed. FIGS. 5A and 5B illustrate general structures of KMAC and HMAC (instantiated with a Merkle-Damgård hash function). Although functioning differently, structurally speaking at a high level, the compression function in the Merkle-Damgård construction method is similar to the state transformation function in the sponge construction method, and the step update function in a Merkle-Damgård hash function like SHA-1/2 is similar to the round function in a sponge hash function like SHA-3, but they make huge differences to white-box implementations of KMAC and HMAC, as discussed below.

1. The core of the Merkle-Damgård construction method is a one-way compression function which maps from a domain to a range that is smaller than the domain. The core of the sponge construction method is a state transformation function which maps from a domain to a range that is equal to the domain, which is usually a permutation like that used in SHA-3. In other words, the compression function of a Merkle-Damgård hash function is irreversible, while the state transformation function of a sponge hash function is usually bijective and thus reversible. As a consequence, if only key extraction attacks are concerned, there is a very simple and efficient white-box implementation for HMAC-SHA-1/2, that is, computing the two internal states immediately after the processes of the two key blocks and then releasing them as initial values for a white-box implementation of HMAC. This is feasible because the two key blocks are the first blocks of the two different hash computations. This simple white-box implementation has a full security against key extraction attacks as long as the underlying hash function is one-way, since none can reverse the two released initial values to extract the keys under a one-way function. However, even when only key extraction attacks are concerned, the simple white-box implementation of HMAC-SHA-1/2 does not apply to KMAC at all, since the release of an internal state from KMAC would enable one to extract the key easily, by reversing the state transformation function F, as F is a permutation. That indicates that a white-box KMAC implementation should protect the internal states even it aims to resist only key extraction attacks, which makes it very close to a white-box KMAC protection against both key extraction and code lifting attacks, with slight extra cost to protect message against code lifting.

2. A Merkle-Damgård hash function usually involves a message expansion function, which first divides a message block into a number of smaller sub-blocks, then extends the sub-blocks into a larger number of sub-blocks of the same length as the original sub-blocks preferably in a non-linear manner like SHA-2, and finally processes the original and extended sub-blocks with a compression function that usually includes an iteration of a step update function, with each step processing a sub-block. However, a sponge hash function like SHA-3 does not involve a message expansion function, and a message block is input once as a whole at the beginning of a state update function.

As a consequence, to design a general white-box implementation against both key extraction and code lifting attacks under one message block, we cannot iteratively use a white-box implementation of the step update function to process the message sub-blocks for a Merkle-Damgård hash function, due to the generally different protection effects on the message sub-blocks, unless forcing them to be protected with the same white-box protections at the expense of losing generality. This is somewhat similar to the fact that we cannot use an iterative manner to make a general white-box AES implementation due to different round keys. However, various example embodiments note that the round function of KMAC takes only an earlier internal state and some fixed constants as input, without message or key, and as a result, various example embodiments advantageously use iteratively a white-box implementation of the round function for KMAC within the 24-round process of a message block.

Various example embodiments note that code lifting attacks require us to protect the correspondence between message and digest (i.e., hash value), so that an attacker cannot produce a correct (original message, original digest) pair which the white-box implementation does not produce before. This can be achieved by either protecting message or digest or protecting both message and digest in a white-box implementation, but the problem that an attacker can produce a correct (protected message, protected digest) pair from a white-box implementation does not belong to this area. In the sense of white-box implementations, there are specific distinctions between KMAC and HMAC-SHA-1/2 or AES, for example: SHA-3 involves only bitwise operations, while SHA-1/2 also involves non-bitwise operation like modular addition; and SHA-3 has no S-box operation, different from DES or AES.

### 4—White-Box Implementation Schema of KMAC

In this section, a white-box implementation method of KMAC according to various example embodiments to prevent key extraction and code lifting attacks to some extent is described.

### 4.1—Implementation Method

To efficiently generate a variable-length digest on a message with an arbitrary length, the white-box KMAC implementation according to various example embodiments uses an iterative process at a few phases and includes of the following processes:

1. To deal with the variable length of an arbitrary message, an iterative manner to process the 1088-bit message block(s) of a message is used; specifically, the white-box implementation output of the F function of a message block should be of the same format as the white-box implementation output of the F function of the previous message block (if any), so that it can be iterated for different 1088-bit message blocks.

2. Within the process of a 1088-bit message block, the round function of F only takes the previous internal state as input, plus a round constant. Another iterative process to process the 24 rounds of the F function is used, and most of the five operations of the round function can be iteratively reused in different rounds, except that the operations dealing with the round constants are dedicated to the respective rounds.

3. Various example embodiments deal with a variable-length digest of more than one blocks long, and iterate the white-box implementation for a message block in the squeezing phase. The white-box implementation of the F function for producing a digest is an iteration of the white-box implementation of the F function for processing a message block, with message input operation being removed, using the same set of white-box protections for both the input and output of the F function of a message block. Thus, there is no message input in the squeezing phase, and the white-box implementation can be reused in the absorbing phase.

4. The white-box implementation treats a 64-bit lane (that is, A[x, y]=(A[x, y, 0]∥A [x, y, 1]∥ . . . ∥A[x, y, 63]) as the basic unit, and treats all the five elementary operations of the round function as some operations on 64-bit lanes, more specifically:
C[(x+1)mod 5, (z−1)mod 64] of Equation (2) mentioned hereinbefore is equivalent to C[(x+1)mod 5]<<<1, where C[(x+1)mod 5]=C[(x+1)mod 5, 0]∥C[(x+1)mod 5,1]∥ . . . ∥C[(x+1)mod 5, 63].

$$A [ x , y , ( z - \frac{( t + 1 ) \times ( t + 2 )}{2} ) mod 64 ]$$

of Equation (3) mentioned hereinbefore is equivalent to

$$A [ x , y ] ≪ < ( \frac{( t + 1 ) \times ( t + 2 )}{2} mod 64 ) .$$

Â[x, y, z]=A[(x+3y mod 5), x, z] of Equation (4) mentioned hereinbefore is equivalent to an reordering of the positions of the 64-bit lanes A[x, y]. Thus, the operation π can be combined together with the last operation ρ.
The operation (A[(x+1)mod 5, y, z]⊕1)×A[(x+2)mod 5, y, z] of Equation (5) mentioned hereinbefore is equivalent to (¬A[(x+1)mod 5, y, z])&A[(x+2)mod 5, y, z]; or simply (¬A[(x+1)mod 5, y])&A[(x+2)mod 5,y] on two 64-bit lanes.
All other operations like ⊕ in Equation (1) mentioned hereinbefore are relatively simple.

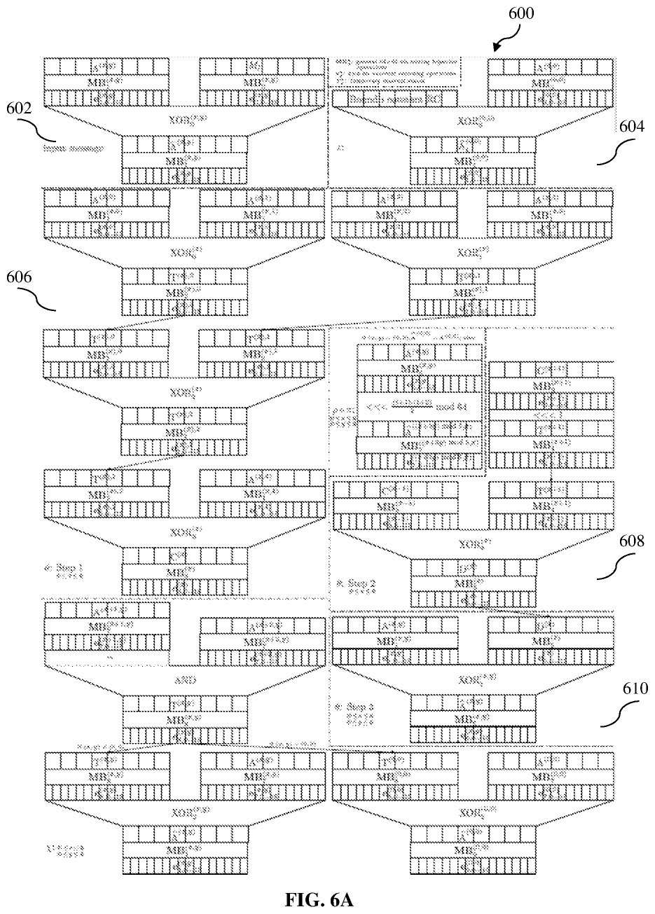

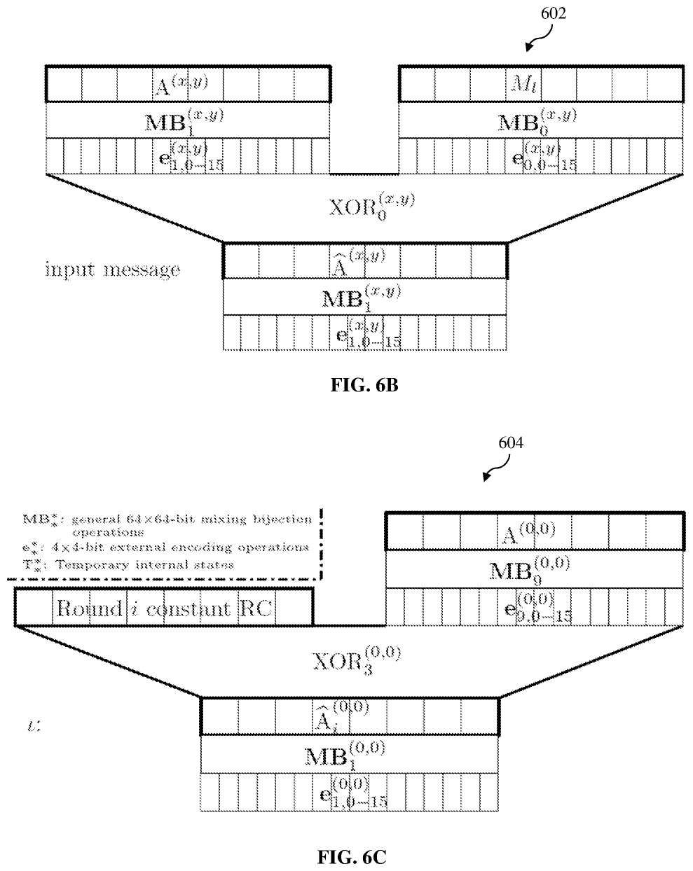

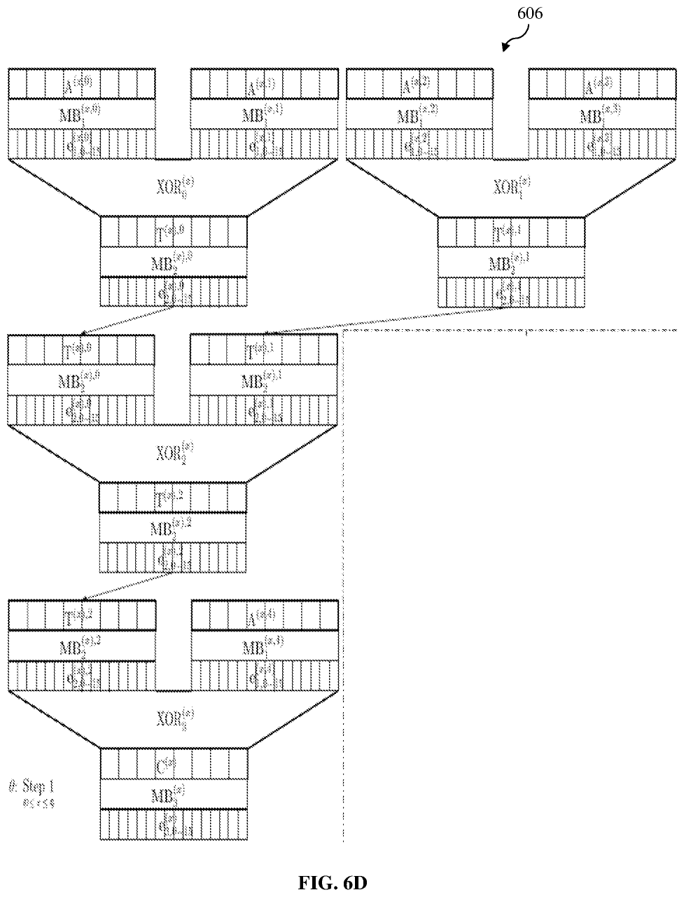

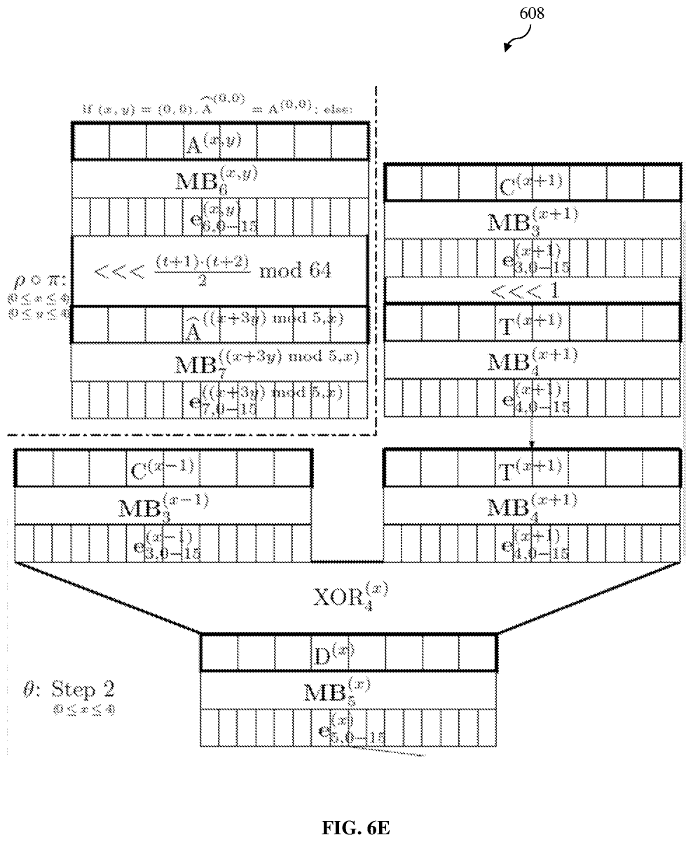

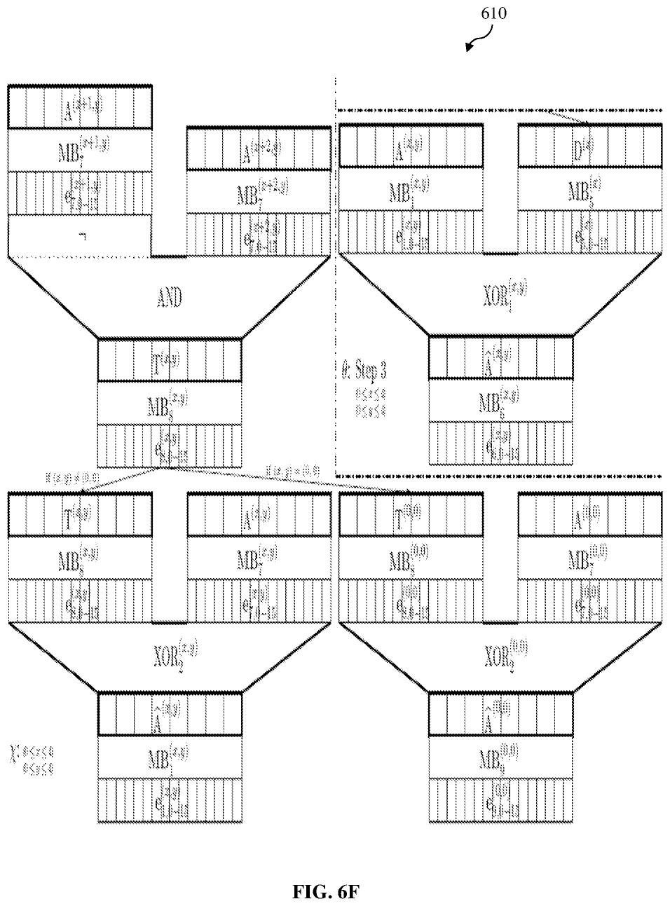

As a result, KMAC involves only bitwise operations on 64-bit words. FIG. 6A illustrates a high-level overview of the white-box implementations 600 of the five operations of the round function. FIGS. 6B to 6F illustrate enlarged versions of portions 602, 604, 606, 608, 610 of FIG. 6A for better clarity.

4.2—Protecting Message against Code Lifting

To protect a 1088-bit message block Mₗ against code lifting (l≥0) to some extent, according to various example embodiments, the server generates its white-box form in the following way:
1. Generate an array of 25 64×64-bit mixing bijection operations MB₀={MB₀^{(x,y)}|0≤x≤4, 0≤y<4}.
2. Generate an array of 400 4×4-bit external encoding operations e_{0,0-15}={e_{0,j}^{(x,y)}|0≤x≤4, 0≤y<4, 0≤15}.
3. The white-box form of Mₗ is e_{0,0-15}(MB₀(Mₗ)).
   In various example embodiments, a mixing bijection operation is a linear operation to provide a diffusion property, for example, matrix multiplication, and an external encoding operation is a non-linear operation to provide confusion property, for example, non-linear substitution.
   4.3—Protecting Key against Key Extraction

To protect key against key extraction to some extent, according to various example embodiments, the server computes F(pad(K)∥0^{c}) and then generates its white-box form in the following way:
1. Generate an array of 25 64×64-bit mixing bijection operations MB₁={MB₁^{(x,y)}|0≤x≤4, 0≤y≤4}.
2. Generate an array of 400 4×4-bit external encoding operations e_{1,0-15}={e_{1,j}^{(x,y)}|0≤x≤4, 0≤y≤4, 0≤j≤15}.
3. Compute e_{1,0-15}(MB₁(F(pad(K)∥0^{c}))), and releases it to the client.

### 5—White-Box Implementations of Basic Operations of KMAC

In this section, a white-box implementation of the basic operations of KMAC is described according to various example embodiments. Finally, a white-box implementation of the five elementary operations of the round function of KMAC is described according to various example embodiments. As a result, the white-box implementation of KMAC is readily achieved according to various example embodiments from the white-box implementation of the five elementary operations. Particularly, a white-box implementation method of the rotation operation is presented. It is assumed X and Y are two 64-bit variables and they are protected in their white-box forms e₀₋₁₅^{X}(MB^{X}(X)) and e₀₋₁₅^{Y}(MB^{Y}(Y)), respectively, where MB^{X} and MB^{Y} are 64×64-bit mixing bijections, and e₀₋₁₅^{X} and e₀₋₁₅^{Y} are two groups of sixteen 4×4-bit external encoding operations.

### 5.1—White-Box Implementation of X⊕Y

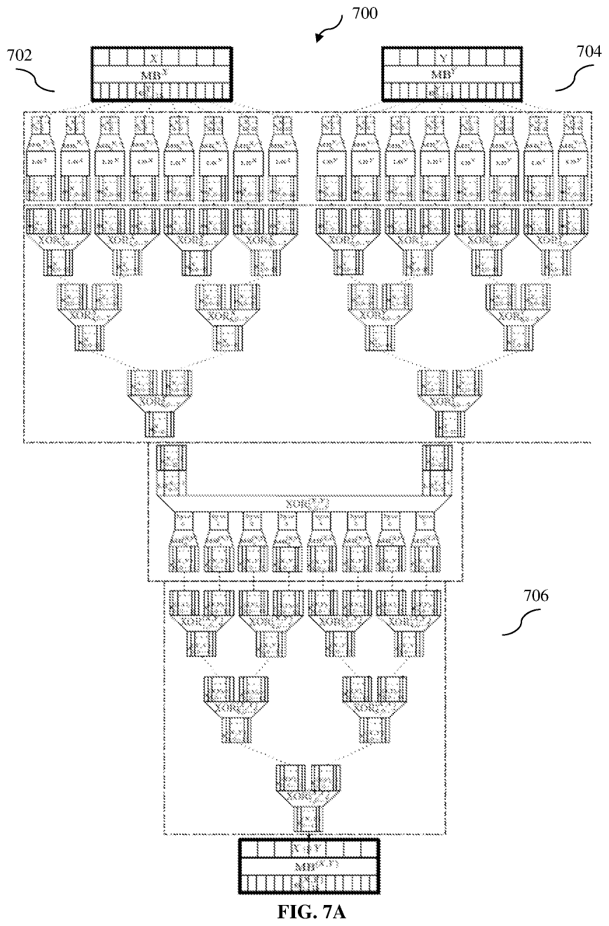

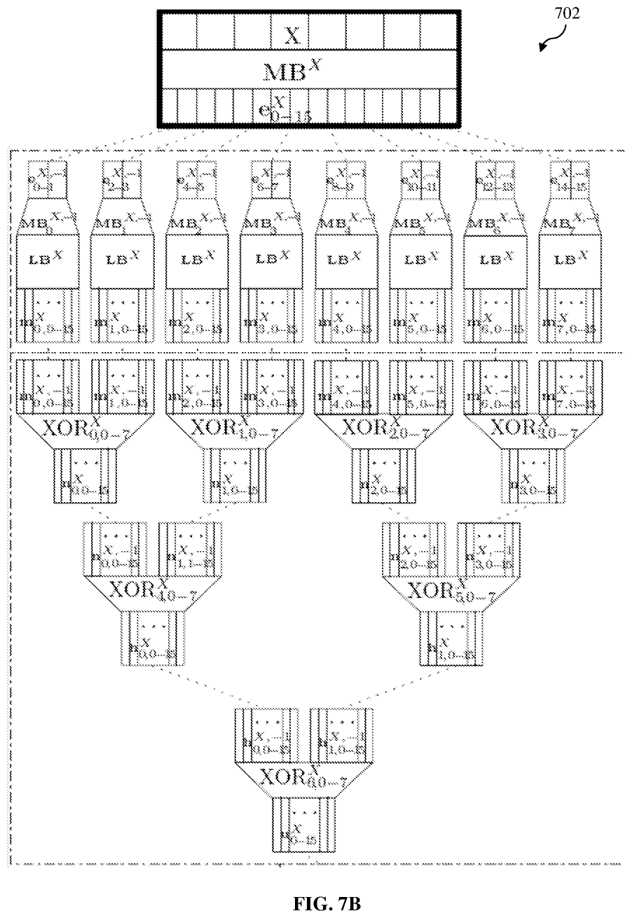

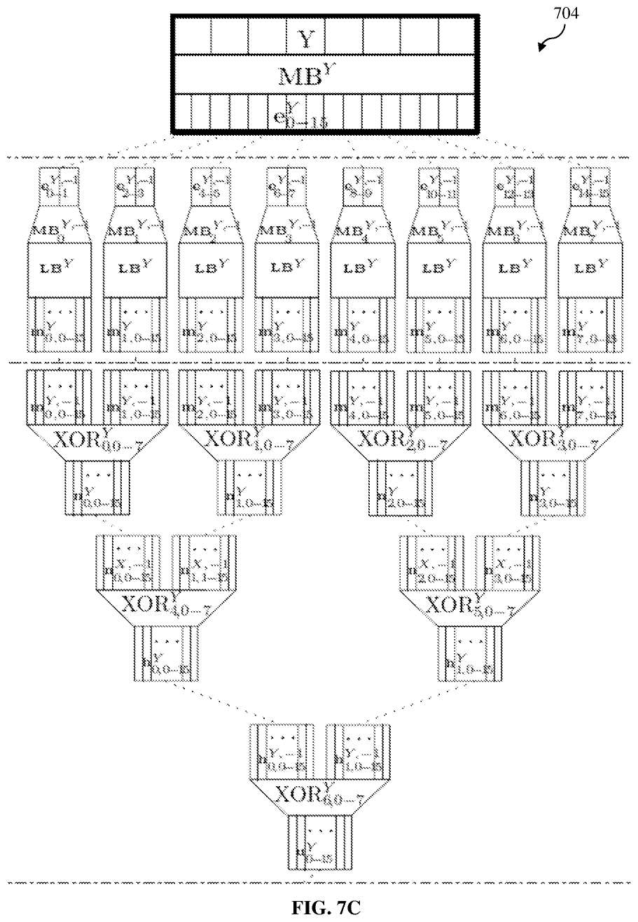

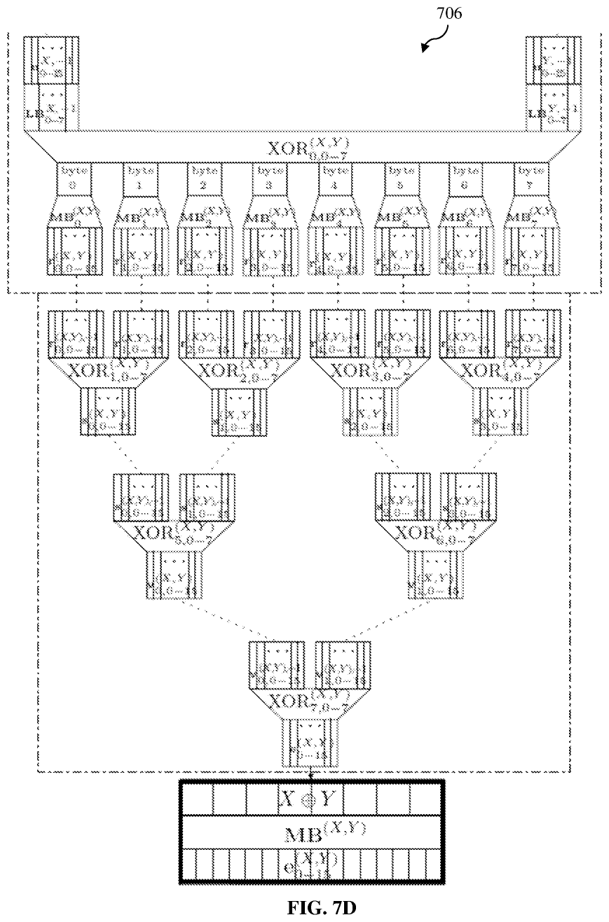

A white-box implementation 700 of X⊕Y according to various example embodiments include four layers at a high level, as illustrated in FIG. 7A. FIGS. 7B to 7D illustrate enlarged versions of portions 702, 704, 706 of FIG. 7A for better clarity.

The first layer is made up of sixteen 8×64-bit tables. For the part processing e₀₋₁₅^{X}(MB^{X}(X)), each 8×64-bit table is generated by applying sequentially the inverses e₂ⱼ₋₍₂ⱼ₊₁₎^{X,-1} of two 4-bit external encoding operations e₂ⱼ₋₍₂ⱼ₊₁₎^{X}, then the corresponding 8×64-bit part MBⱼ^{X,-1} of the inverse MB^{X,-1} of the mixing bijection operation MB^{X}, next a 64×64-bit mixing bijection operation LB^{X}, and finally a parallel series of sixteen 4-bit external encoding operations m_{j,0-15}^{X}, where LB^{X} is of the following form:

$$( \begin{matrix}{LB}_{0}^{X} & 0 & 0 & 0 & 0 & 0 & 0 & 0 \\ 0 & {LB}_{1}^{X} & 0 & 0 & 0 & 0 & 0 & 0 \\ 0 & 0 & {LB}_{2}^{X} & 0 & 0 & 0 & 0 & 0 \\ 0 & 0 & 0 & {LB}_{3}^{X} & 0 & 0 & 0 & 0 \\ 0 & 0 & 0 & 0 & {LB}_{4}^{X} & 0 & 0 & 0 \\ 0 & 0 & 0 & 0 & 0 & {LB}_{5}^{X} & 0 & 0 \\ 0 & 0 & 0 & 0 & 0 & 0 & {LB}_{6}^{X} & 0 \\ 0 & 0 & 0 & 0 & 0 & 0 & 0 & {LB}_{7}^{X}\end{matrix} ) ,$$

with LBⱼ^{X} being invertible 8×8-bit matrices, MB^{X,-1}=(MB₀^{X,-1}, MB₁^{X,-1}, . . . , MB₇^{X,-1}), and j=0, 1, . . . , 7. Similarly for the part processing e₀₋₁₅^{Y}(MB^{Y}(Y).

The second layer is made up of 112 16×8-bit tables XOR_{j,l}^{X} and XOR_{j,l}^{Y}. The final output of the tables XOR_{j,l}^{X} is X protected by the 64×64-bit mixing bijection LB^{X} and a parallel series of sixteen 4-bit external encoding operations u₀₋₁₅^{X}; and the final output of the tables XOR_{j,l}^{Y} is Y protected by the 64×64-bit mixing bijection LB^{Y} and a parallel series of sixteen 4-bit external encoding operations u₀₋₁₅^{Y}, where j=0, 1, . . . , 6, l=0, 1, . . . , 7. To generate each XOR_{j,l}^{X} or XOR_{j,l}^{Y}, we apply the inverses of the corresponding two 4-bit external encoding operations from the previous operation for either 8-bit input, and apply two 4-bit external encoding operations to protect the 8-bit output of the XOR operation.

The third layer is made up of eight 16×64-bit table XOR_{0,l}^{(X,Y)}, where l=0, 1, . . . , 7. Each XOR_{0,l}^{(X,Y)} table is generated by applying sequentially the inverses of the two corresponding 4-bit external encoding operations from the second layer, then the inverse LBₗ^{X,-1} (or LBₗ^{Y,-1}, respectively) of the corresponding 8×8-bit part LBₗ^{X} (or LBₗ^{Y}, respectively) of the mixing bijection operation LB^{X} (or LB^{Y}, respectively) for either 8-bit input, followed by the XOR value of the two resulting 8-bit values, and finally we apply an 8×64-bit mixing operation MBₗ^{(X,Y)} out of a 64×64-bit mixing bijection operation MB^{(X,Y)}, plus a parallel series of sixteen 4-bit external encoding operations r_{l,0-15}^{(X,Y)} to protect the 8-bit output of the XOR operation, where MB^{(X,Y)}=(MB₀^{(X,Y)}, MB₁^{(X,Y)}, . . . , MB₇^{(X,Y)}).

The last (i.e. fourth) layer is made up of fifty-six 16×8-bit tables XOR_{j,l}^{(X,Y)}, with the result X⊕Y being protected by the 64×64-bit mixing bijection MB^{(X,Y)} and a parallel series of sixteen 4-bit external encoding operations e₀₋₁₅^{(X,Y)}, where j=1, 2, . . . , 7, l=0, 1, . . . , 7. To generate each XOR_{j,l}^{(X,Y)}, we apply the inverses of the corresponding two 4-bit external encoding operations from the previous operation for either 8-bit input, and apply two 4-bit external encoding operations to protect the 8-bit output of the XOR operation.

### 5.2—White-Box Implementation of (¬X) & Y

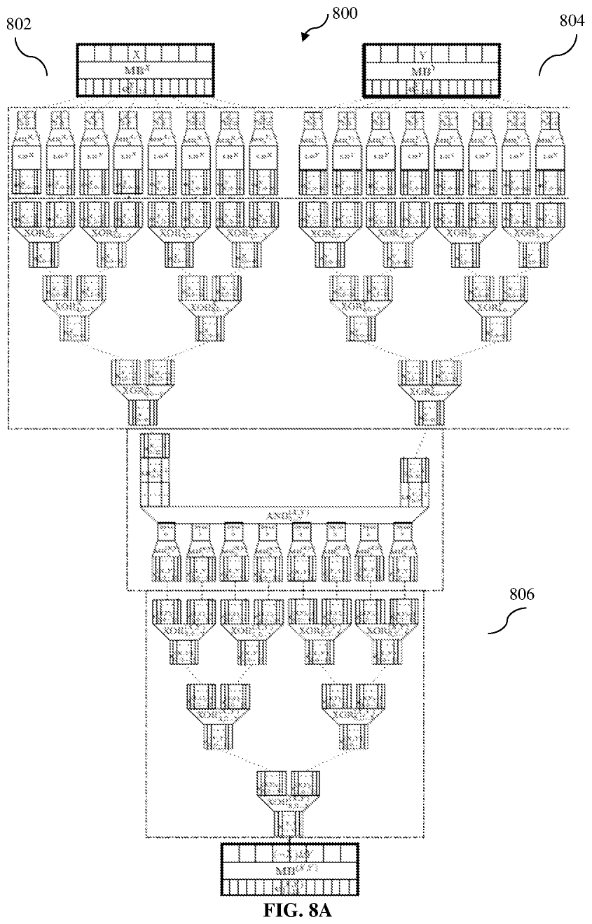

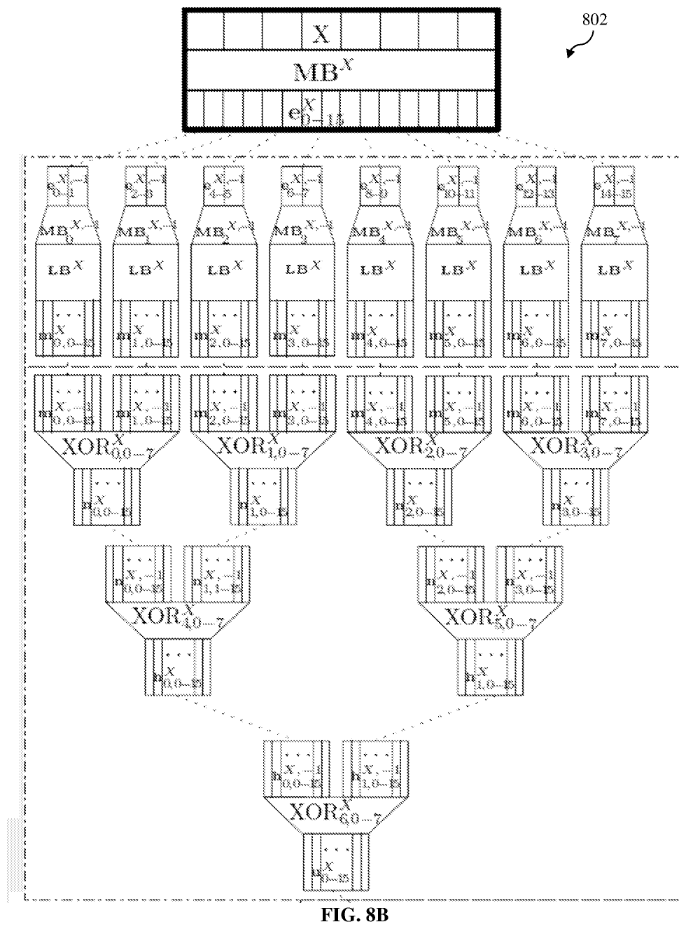

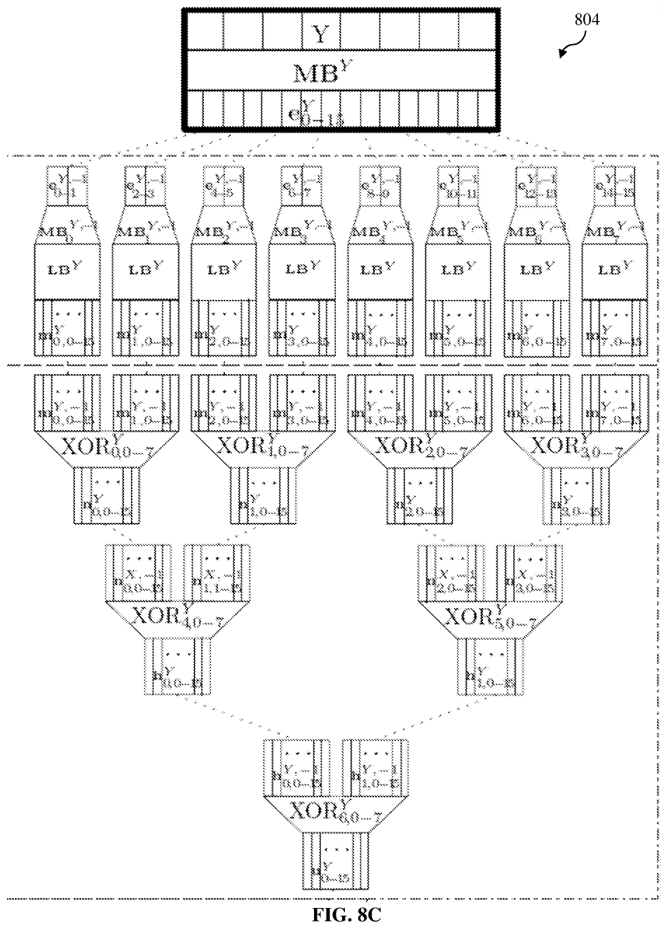

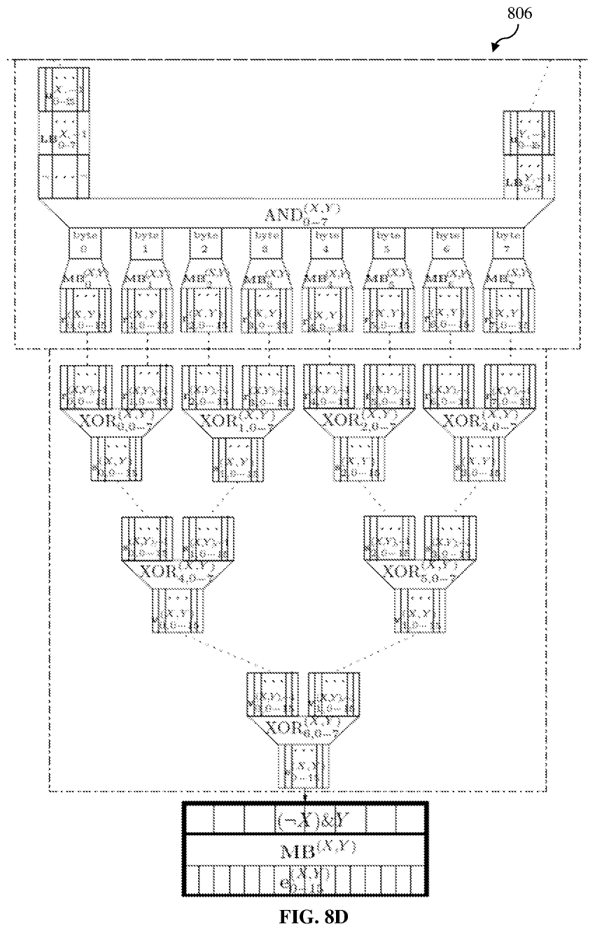

A white-box implementation 800 of the (¬X) &Y is formed according to various example embodiments by slightly modifying the third layer of the above white-box implementation of X⊕Y, as illustrated in FIG. 8A. FIGS. 8B to 8D illustrate enlarged versions of portions 802, 804, 806 of FIG. 8A for better clarity. It includes four layers at a high level, is similar to that described in Section 5.1 for X⊕Y except the third layer.

The third layer is made up of eight 16×64-bit table ANDₗ^{(X,Y)}, where l=0, 1, . . . , 7. Each ANDₗ^{(X,Y)} table is generated by applying sequentially the inverses of the two corresponding 4-bit external encoding operations from the second layer and then the inverse LBₗ^{X,-1} (or LBₗ^{Y,-1}, respectively) of the corresponding 8×8-bit part LBₗ^{X} (or LBₗ^{Y}, respectively) of the mixing bijection operation LB^{X} (or LB^{Y}, respectively) for either 8-bit input, next the bitwise complement operation ¬ only for the 8-bit input from X, followed by the AND value of the two resulting 8-bit values, and finally we apply an 8×64-bit mixing operation MBₗ^{(X,Y)} out of a 64×64-bit mixing bijection operation MB^{(X,Y)}, plus a parallel series of sixteen 4-bit external encoding operations r_{l,0-15}^{(X,Y)} to protect the 8-bit output of the XOR operation.

### 5.3—White-Box Implementation of X<<<α

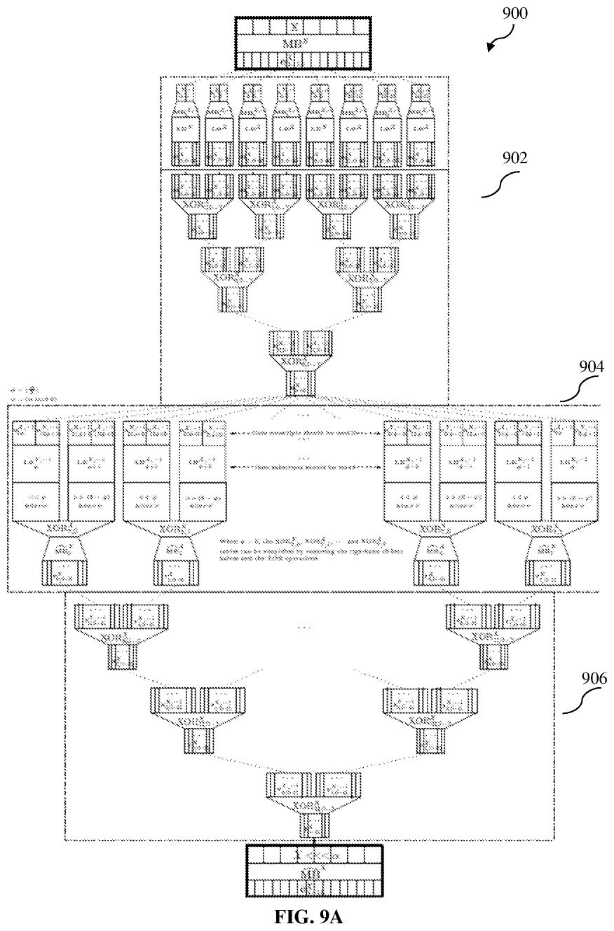

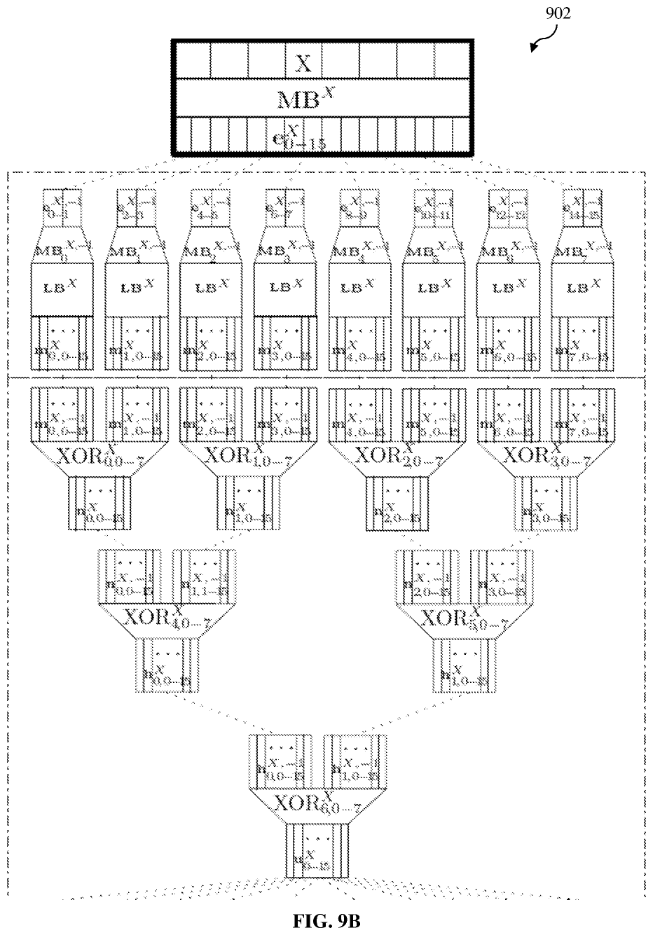

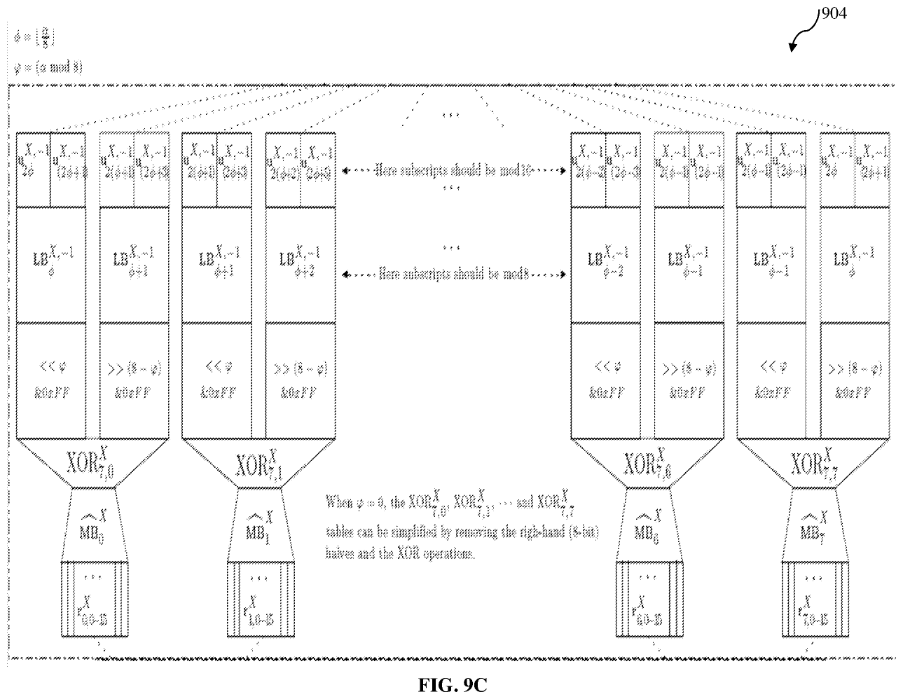

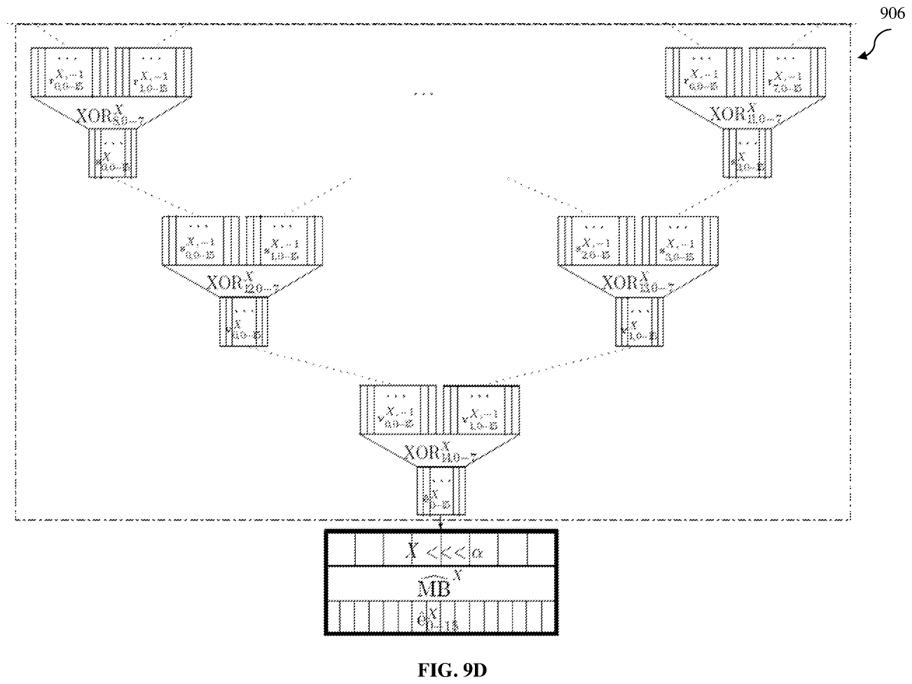

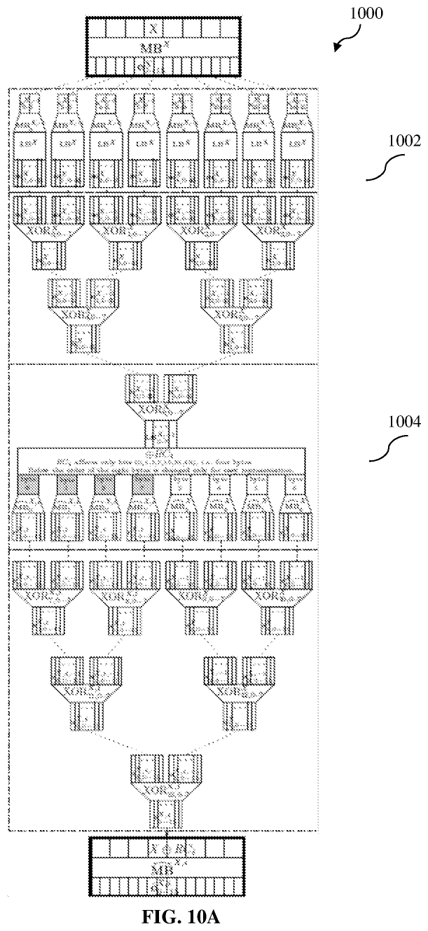

X<<<α is usually obtained by XORing one left shift with one right shift in a general implementation, however, various example embodiments identified that its corresponding white-box implementation is not efficient, which would require white-box operations of two shift operations plus a white-box XOR. In contrast, according to various example embodiments, a white-box implementation of X<<<α is presented, which includes four layers at a high level as illustrated in FIG. 9A (0<α<64). FIGS. 9B to 9D illustrate enlarged versions of portions 902, 904, 906 of FIG. 9A for better clarity.

The first layer is made up of eight 8×64-bit tables, which is exactly the same as the first layer described in Section 5.1 for e₀₋₁₅^{X}(MB^{X}(X)).

The second layer is made up of fifty-six 16×8-bit tables XOR_{j,l}^{X}, which is exactly the same as the second layer described in Section 5.1 for e₀₋₁₅^{X}(MB^{X}(X)).

The third layer is made up of eight 16×64-bit tables XOR_{7,j}^{X}, where j=0, 1, . . . , 7. Each XOR_{7,j}^{X} table is generated by applying sequentially the inverses of the two corresponding 4-bit external encoding operations from the second layer and then the inverse LB_{(ϕ+j)mod 8}^{X,-1} (or LB_{(ϕ+j+1)mod 8}^{X,-1}, respectively) of the corresponding 8×8-bit part LB_{(ϕ+j)mod 8}^{X} (or LB_{(ϕ+j+1)mod 8}^{X}, respectively) of the mixing bijection operation LB^{X} for either 8-bit input, next the operations (<<φ)° (&0xFF) or (>>(8−φ))° (&0xFF) for either 8-bit input, followed by the XOR value of the two resulting 8-bit values, and finally an 8×64-bit mixing operation [symbol] ⱼ^{X} out of a 64×64-bit mixing bijection operation [symbol] ^{X} is applied, plus a parallel series of sixteen 4-bit external encoding operations r_{j,0-15}^{X} to protect the 8-bit output of the XOR operation, where

$$∅ = ⌊ \frac{α}{8} ⌋ ,$$

φ=α mod 8, and [symbol] ^{X}=( [symbol] ₀^{X}, [symbol] ₁^{X}, . . . , [symbol] ₇^{X}).

The last (i.e. fourth) layer is made up of fifty-six 16×8-bit tables XOR_{j,l}^{X}, with the result X<<<α being protected by the 64×64-bit mixing bijection [symbol] ^{X} and a parallel series of sixteen 4-bit external encoding operations ê₀₋₁₅^{X}, where j=8, 9, . . . , 14, l=0, 1, . . . , 7. To generate each XOR_{j,l}^{X}, the inverses of the corresponding two 4-bit external encoding operations from the previous operation are applied for either 8-bit input, and two 4-bit external encoding operations are applied to protect the 8-bit output of the XOR operation.

Various example embodiments note that that when φ=0, the eight 16×64-bit tables XOR_{7,0}^{X}, XOR_{7,1}^{X}, . . . and XOR_{7,7}^{X} can be simplified into eight 8×64-bit tables by removing the right-hand (8-bit) halves and the XOR operations.

In KMAC, various example embodiments note that there exist only the cases of X<<<1 and

$$X ≪ < ( \frac{( t + 1 ) \times ( t + 2 )}{2} mod 64 ) ,$$

where the former is the operation C[(x−1)mod 5]<<<1 of Equation (2) mentioned hereinbefore and the latter is the equivalent operation

$$A [ x , y ] ≪ < ( \frac{( t + 1 ) \times ( t + 2 )}{2} ) mod 64$$

of Equation (3) as mentioned hereinbefore.

### 5.4—White-Box Implementation of X⊕RCᵢ

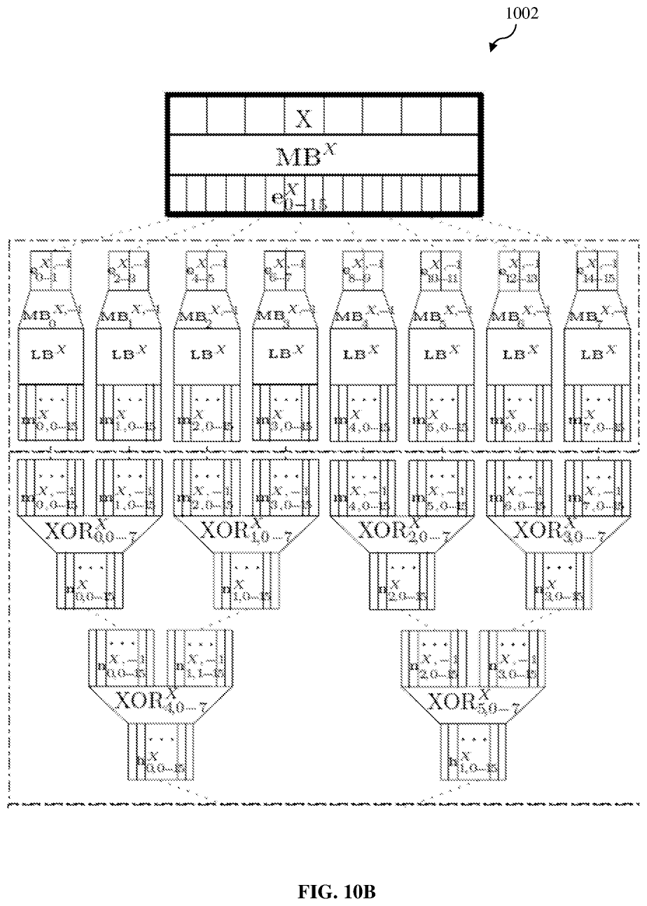

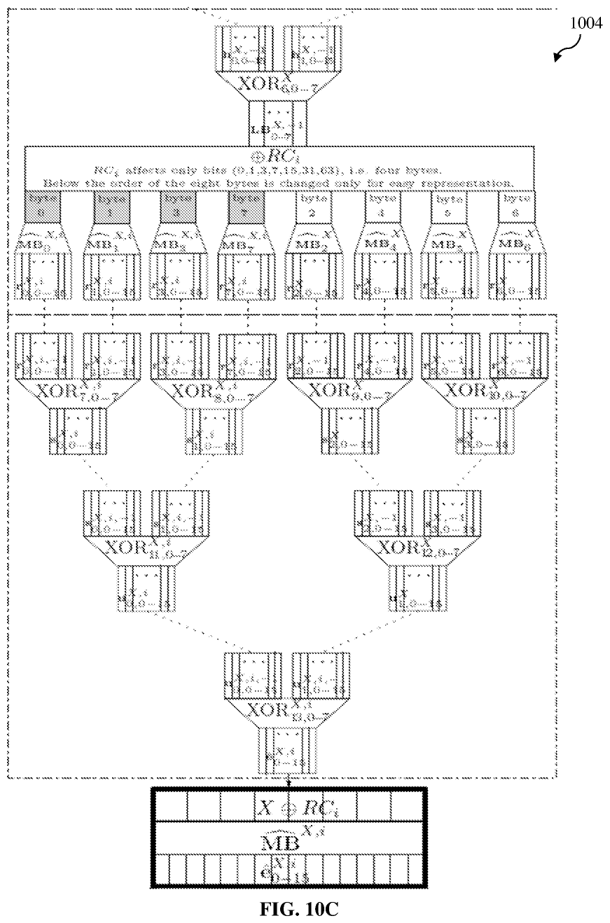

According to various example embodiments, a white-box implementation 1000 of the X⊕RCᵢ is obtained by simplifying the above white-box implementation of X⊕Y when Y is a public constant. It includes four layers at a high level, as illustrated in FIG. 10A. FIGS. 10B and 10C illustrate enlarged versions of portions 1002, 1004 of FIG. 10A for better clarity.

The first layer is made up of eight 8×64-bit tables, which is exactly the same as the first layer described in Section 5.1 for e₀₋₁₅^{X}(MB^{X} (X)).

The second layer is made up of forty-eight 16×8-bit tables XOR_{j,l}^{X}, which is similar to the second layer described in Section 5.1 for e₀₋₁₅^{X}(MB^{X}(X)), except that the last table XOR_{6,l}^{X} is not at present here.

The third layer is made up of eight 16×64-bit tables XOR_{6,l}^{X}, where l=0, 1, . . . , 7. Each XOR_{6,l}^{X} table is generated by applying sequentially the inverses of the two corresponding 4-bit external encoding operations from the second layer for either 8-bit input, then the XOR value of the two resulting 8-bit values, next the inverse of the corresponding 8×8-bit part LBₗ^{X} of the mixing bijection operation LBₗ^{X,-1} followed by the XOR operation with the corresponding 8-bit part from RCᵢ, and finally an 8×64-bit mixing operation [symbol] ₗ^{X,i} or [symbol] ₗ^{X} out of a 64×64-bit mixing bijection operation [symbol] ^{X,i} is applied, plus a parallel series of sixteen 4-bit external encoding operations r_{l,0-15}^{X,i} or r_{l,0-15}^{X} to protect the 8-bit output of the XOR operation, where [symbol] ^{X,i}=( [symbol] ₀^{X,i}, [symbol] ₁^{X,i}, [symbol] ₂^{X,i}, [symbol] ₃^{X,i}, [symbol] ₄^{X}, [symbol] ₅^{X}, [symbol] ₆^{X}, [symbol] ₇^{X,i}), and i is the round index. Note that RCᵢ affects only 4 bytes of a 64-bit lane.

The last (i.e. fourth) layer is made up of fifty-six 16×8-bit tables XOR_{j,l}^{X,i} or XOR_{j,l}^{X}, which is similar to the second layer described in Section 5.1 for e₀₋₁₅^{X}(MB^{X}(X)), except that some of the XOR tables are dedicated to Round i and the others of the XOR tables can be reused in all the 24 rounds.

### 6—An Efficient White-Box KMAC Implementation

In this section, a white-box implementation of KMAC according to various example embodiments is formed by composing the five elementary operations of the round function with the basic white-box operations.

### 6.1—White-Box Implementation of θ

As illustrated in FIG. 6A, according to various example embodiments, white-box implementation of θ can be composed by the above white-box implementations of ⊕ and <<<. More specifically, Step 1 is composed of three applications of the white-box implementation of X⊕Y; Step 2 is composed of one application of the white-box implementation of <<< and one application of the white-box implementation of X⊕Y; and Step 3 is composed of one application of the white-box implementation of X⊕Y.

### 6.2—White-Box Implementation of ρ°π

As illustrated in FIG. 6A, according to various example embodiments, white-box implementation of ρ° π can be composed by one application of the above white-box implementation of <<<.

### 6.3—White-Box Implementation of χ

As illustrated in FIG. 6A, according to various example embodiments, white-box implementation of χ can be composed by one application of the above white-box implementation of (¬X) & Y and one application of the above white-box implementation of ⊕.

### 6.4—White-Box Implementation of ι

As illustrated in FIG. 6A, according to various example embodiments, white-box implementation of ι can be composed by one application of the above white-box implementation of X⊕RCᵢ.

### 6.5—White-Box KMAC

As a result, a white-box implementation of KMAC according to various example embodiments can be readily built from the above white-box implementations of the five elementary operations, as shown in FIG. 3. Various example embodiments note that the starting A^{(x,y)} for the white-box KMAC lies in the input message part of FIG. 3, which is e_{1,0-15}(MB₁(F(pad(K)∥0^{c})). Subsequent white-box operations follow the KMAC specifications.

Various example embodiments observe that this white-box KMAC implementation also works when the user key is updated, that is, the same set of white-box tables can be reused for different user keys, as long as the server releases the corresponding protected form of the new key to the client. Thus, the server does not need to generate another set of white-box tables every time a user key is updated, which reduces computational and communication complexity. Of course, it is better to limit the maximum number of keys used under a set of white-box tables, to avoid a security loss in this situation.

### 7—Observations

Various example embodiments provide a white-box implementation method of rotation operation and an efficient white-box KMAC implementation, which can practically resist both key extraction and code lifting attacks and can still work with an updated user key. White-box implementation methods according to various example embodiments can be used to develop white-box implementations for other cryptographic algorithms like variants and extensions of the sponge construction.

In the sense of security and key update, white-box cryptography is more friendly to MACs than to block ciphers: In the case of block ciphers, the user key usually gets closely involved into a system of algebraic expressions with messages, which may allow an attacker to recover the key by solving the expressions given a sufficient number of messages, and a new set of white-box tables should be generated every time the user key is updated, but in the case of MACs the protected form of the first hash computation result on the user key is like a secret initialization vector and it is not necessarily compulsory to regenerate new white-box tables when a key is updated.

Accordingly, in the various examples, the white-box implementation of KMAC can prevent key extraction and code lifting attacks, takes advantage of KMAC features for an iterative process at different phases, and efficiently produce an arbitrary-length digest for a variable-length message. According to various example embodiments, the various phrases include:
a preprocessing phase which involves the server computing the output of the state update function after the key block and protecting it with white-box operations to prevent key extraction;
white-box phase to compute the output of the state update function after the message blocks; and
a white-box phase to compute the final message digest.

According to various example embodiments, a method of securing a message authentication code, in particular, a KMAC message authentication code, against code lifting and key extraction is provided. The method comprises generating a variable-length digest on the message with an arbitrary length, processing the 1088-bit message blocks of the message iteratively (in an absorbing phase), whereby the format of the message block is the same as the format of preceding message block, whereby the round function of a state transformation only takes the previous internal state as input, plus a round constant, whereby the processing of the state transformation is over 24 rounds, and whereby the round function of the state transformation can be iteratively reused in different rounds, except that the operations dealing with the round constants are dedicated to the respective rounds.

The method may further include processing a variable-length digest of more than one blocks long of a message block in a squeezing phase iteratively to produce a digest of the a state transformation function for processing a message block with message input operation being removed, for both the input and output of the state transformation function of a message block such that there is no message input in the squeezing phase; and re-using the digest of the a state transformation in the absorbing phase.

While embodiments of the invention have been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A method of generating a Keccak message authentication code (KMAC) based on white-box implementation, using at least one processor, the method comprising:
obtaining a white-box implementation of a round function of a KMAC algorithm;
receiving an input message;
obtaining a plurality of message blocks based on the input message; and
for each of the plurality of message blocks at a plurality of iterations, respectively:
modifying a current state of the KMAC algorithm based on the message block to produce a modified current state of the KMAC algorithm;
inputting the modified current state to a state transformation function comprising the white-box implementation of the round function; and
executing the white-box implementation of the round function based on the modified current state to obtain an updated state of the KMAC algorithm as an output of the state transformation function,
wherein the modified current state inputted to the state transformation function and the updated state outputted from the state transformation function are each white-box protected based on a same set of white-box operations.

2. The method according to claim 1, wherein
said modifying the current state comprises performing an exclusive OR (XOR) operation between the current state and the message block,
the current state and the message block are each white-box protected, and
the current state is white-box protected based on said same set of white-box operations.

3. The method according to claim 1, wherein
said executing the white-box implementation of the round function based on the modified current state comprises executing the white-box implementation of the round function iteratively in a plurality of rounds, and
at each round of the plurality of rounds, a state of the KMAC algorithm input to the white-box implementation of the round function and a state of the KMAC algorithm output from the white-box implementation of the round function are each white-box protected based on said same set of white-box operations.

4. The method according to claim 3, wherein
the white-box implementation of the round function comprises a plurality of component white-box implementations for a plurality of elementary operations of the round function, and
at least one of the plurality of component white-box implementations are used in the white-box implementation of the round function at each of the plurality of rounds.

5. The method according to claim 4, wherein
at least one of the plurality of component white-box implementations are used in the white-box implementation of the round function at each of the plurality of iterations with respect to the plurality of message blocks.

6. The method according to claim 4, wherein
the plurality of elementary operations of the round function comprises a theta operation, a rho operation, a pi operation, a chi operation and an iota operation, and
the plurality of component white-box implementations comprises a first component white-box implementation for the theta operation, a second component white-box implementation for the rho and pi operations, a third component white-box implementation for the chi operation and a fourth white-box implementation for the iota operation.

7. The method according to claim 6, wherein
the first component white-box implementation, the second component white-box implementation and the third component white-box implementation are used at the white-box implementation of the round function at each of the plurality of rounds.

8. The method according to claim 6, wherein
the first and second component white-box implementations each comprises a first basic white-box implementation of a rotation operation, the first basic white-box implementation comprising a plurality of white-box implementations for a plurality of parallel XOR operations, wherein each white-box implementation for each of the plurality of parallel XOR operations:
inputs two adjacent fractions of an input to the first basic white-box implementation as two input operands;
applies left shift and right shift operations to the two adjacent fractions, respectively, to obtain a first fraction output and a second fraction output; and
performs an XOR operation between the first fraction output and the second fraction output.

9. The method according to claim 6, wherein
the fourth component white-box implementation comprises a second basic white-box implementation of a round constant related XOR operation for each of the plurality of rounds, wherein the second basic white-box implementation for each round after a first round of the plurality of rounds only updates white-box operations related to output bytes of an XOR operation affected by a round constant for the round, and for remaining output bytes of the XOR operation unaffected by the round constant, reuse white-box operations related to corresponding output bytes of the second basic white-box implementation at the first round.

10. The method according to claim 1, wherein
said same set of white-box operations is a global set of white-box operations with respect to the KMAC algorithm, and
said same set of white-box operations comprises an array of mixing bijection operations and an array of external encoding operations.

11. A system for generating a Keccak message authentication code (KMAC) based on white-box implementation, the system comprising:
a memory; and
at least one processor communicatively coupled to the memory and configured to:
obtain a white-box implementation of a round function of a KMAC algorithm;
receive an input message;
obtain a plurality of message blocks based on the input message; and
for each of the plurality of message blocks at a plurality of iterations, respectively:
modify a current state of the KMAC algorithm based on the message block to produce a modified current state of the KMAC algorithm;
input the modified current state to a state transformation function comprising the white-box implementation of the round function; and
execute the white-box implementation of the round function based on the modified current state to obtain an updated state of the KMAC algorithm as an output of the state transformation function,
wherein the modified current state inputted to the state transformation function and the updated state outputted from the state transformation function are each white-box protected based on a same set of white-box operations.

12. The system according to claim 11, wherein
said modify the current state comprises performing an exclusive OR (XOR) operation between the current state and the message block,
the current state and the message block are each white-box protected, and
the current state is white-box protected based on said same set of white-box operations.

13. The system according to claim 11, wherein
said execute the white-box implementation of the round function based on the modified current state comprises executing the white-box implementation of the round function iteratively in a plurality of rounds, and
at each round of the plurality of rounds, a state of the KMAC algorithm input to the white-box implementation of the round function and a state of the KMAC algorithm output from the white-box implementation of the round function are each white-box protected based on said same set of white-box operations.

14. The system according to claim 13, wherein
the white-box implementation of the round function comprises a plurality of component white-box implementations for a plurality of elementary operations of the round function,
at least one of the plurality of component white-box implementations are used in the white-box implementation of the round function at each of the plurality of rounds, and
at least one of the plurality of component white-box implementations are used in the white-box implementation of the round function at each of the plurality of iterations with respect to the plurality of message blocks.

15. The system according to claim 14, wherein
the plurality of elementary operations of the round function comprises a theta operation, a rho operation, a pi operation, a chi operation and an iota operation, and
the plurality of component white-box implementations comprises a first component white-box implementation for the theta operation, a second component white-box implementation for the rho and pi operations, a third component white-box implementation for the chi operation and a fourth white-box implementation for the iota operation.

16. The system according to claim 15, wherein
the first component white-box implementation, the second component white-box implementation and the third component white-box implementation are used at the white-box implementation of the round function at each of the plurality of rounds.

17. The system according to claim 16, wherein
the first and second component white-box implementations each comprises a first basic white-box implementation of a rotation operation, the first basic white-box implementation of the rotation operation comprising a plurality of white-box implementations for a plurality of parallel XOR operations, wherein each white-box implementation for each of the plurality of parallel XOR operations is configured to:
input two adjacent fractions of an input to the first basic white-box implementation as two input operands;
apply left shift and right shift operations to the two adjacent fractions, respectively, to obtain a first fraction output and a second fraction output; and
perform an XOR operation between the first fraction output and the second fraction output.

18. The system according to claim 16, wherein
the fourth component white-box implementation comprises a second basic white-box implementation of a round constant related XOR operation for each of the plurality of rounds, wherein the second basic white-box implementation for each round after a first round of the plurality of rounds is configured to only updates white-box operations related to output bytes of an XOR operation affected by a round constant for the round, and for remaining output bytes of the XOR operation unaffected by the round constant, reuse white-box operations related to corresponding output bytes of the second basic white-box implementation at the first round.

19. The system according to claim 11, wherein
said same set of white-box operations is a global set of white-box operations with respect to the KMAC algorithm, and
said same set of white-box operations comprises an array of mixing bijection operations and an array of external encoding operations.

20. A computer program product, embodied in one or more non-transitory computer-readable storage mediums, comprising instructions executable by at least one processor to perform a method of generating a Keccak message authentication code (KMAC) based on white-box implementation, the method comprising:
obtaining a white-box implementation of a round function of a KMAC algorithm;
receiving an input message;
obtaining a plurality of message blocks based on the input message; and
for each of the plurality of message blocks at a plurality of iterations, respectively:
modifying a current state of the KMAC algorithm based on the message block to produce a modified current state of the KMAC algorithm;
inputting the modified current state to a state transformation function comprising the white-box implementation of the round function; and
executing the white-box implementation of the round function based on the modified current state to obtain an updated state of the KMAC algorithm as an output of the state transformation function,
wherein the modified current state inputted to the state transformation function and the updated state outputted from the state transformation function are each white-box protected based on a same set of white-box operations.
